(19) United States
(12) Patent Application Publication
(10) Pub. No.: US 2026/0035808 A1
(43) Pub. Date: Feb. 5, 2026

(54) ELECTROCATALYTIC HYDROGENATION OF MUCONIC ACID

(71) Applicant: Iowa State University Research Foundation, Inc., Ames, IA (US)

(72) Inventors: Jean-Philippe Tessonnier, Ames, IA (US); Luke T. Roling, Ames, IA (US); Prathamesh T. Prabhu, Ames, IA (US); Deep M. Patel, Ames, IA (US); Devanshi B. Mistry, Ames, IA (US); Marco Nazarenno Dell'Anna, Chicago, IL (US)

(21) Appl. No.: 19/263,337

(22) Filed: Jul. 8, 2025

Related U.S. Application Data
(60) Provisional application No. 63/668,999, filed on Jul. 9, 2024.

(51) Int. Cl. C25B 3/07; C08G 69/26; C25B 3/25; C25B 11/081

(52) U.S. Cl. CPC C25B 3/07; C08G 69/265; C25B 3/25; C25B 11/081

(57) ABSTRACT

An electrocatalytic method includes passing current through a catalytic cathode in a reactor including an aqueous solution including the muconic acid, a supporting electrolyte, and an anode, so as to hydrogenate the muconic acid to yield a product including 3-hexene-1,6-dioic acid, 2-hexene-1,6-dioic acid, adipic acid, or a mixture thereof. An electrocatalytic method includes passing current through a catalytic cathode in a reactor including an aqueous solution including an organic substrate, a supporting electrolyte, and an anode, so as to electrocatalytically convert the organic substrate, wherein the aqueous solution includes a fermentation broth including the organic substrate and including one or more catalyst poisons that reduce catalytic activity of the catalytic cathode; removing one or more catalyst poisons from the catalytic cathode to form a rejuvenated catalytic cathode; and reusing the rejuvenated catalytic cathode in the method.

### CROSS-REFERENCE TO RELATED APPLICATION

This application claims the benefit of priority to U.S. Provisional Patent Application Ser. No. 63/668,999 filed Jul. 9, 2024, the disclosure of which is incorporated herein in its entirety by reference.

### STATEMENT OF GOVERNMENT SUPPORT

This invention was made with Government support under EFMA2132200 awarded by the National Science Foundation. The Government has certain rights in the invention.

### BACKGROUND

The contemporary trajectory of economic and societal advancement exhibits a pronounced reliance on fossil fuels and petrochemicals. This dependence is driven by factors such as reduced production costs, prolific availability, and the extensive array of conversion technologies that have evolved through years of research and development. These attributes collectively render fossil fuels and petrochemicals pivotal as the predominant sources of energy and raw materials. The contemporary technological landscape, characterized by diversification, facilitates the transformation of these hydrocarbon feedstocks into a myriad of value-added products, encompassing plastics, surfactants, cosmetics, lubricants, and the like. Nevertheless, the petroleum industry has matured to a juncture wherein further advancements predominantly entail refinements in process efficiency and the assimilation of cost-advantaged feedstocks, such as shale gas. Concurrently, the unwarranted exploitation of fossil fuel reservoirs has precipitated far-reaching consequences on global climate patterns, thereby exerting adverse effects on ecosystems worldwide. In response to this conundrum and the associated environmental repercussions, the chemical industry is actively endeavoring to effectuate a paradigm shift towards sustainable practices, notably by exploring renewable energy sources, such as biomass, as substitutes for conventional fossil resources.

As shown in Scheme 1, muconic acid (“MA”) is an unsaturated dicarboxylic acid, hexa-2,4-dienedioic acid, which can exist in three isomeric forms.

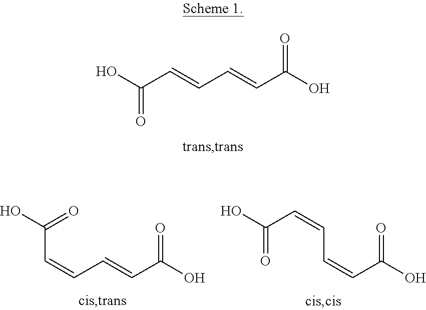 [SMILES: O=C(O)/C=C/C=C/C(=O)O ; O=C(O)/C=C\C=C\C(=O)O ; O=C(O)/C=C\C=C/C(=O)O]

Muconic acid can be produced from biomass; as such, muconic acid has garnered significant interest due to its potential use as a platform chemical for the production of several valuable consumer bio-plastics including nylon 6,6, polyurethane (via an adipic acid intermediate), and polyethylene terephthalate (PET) (via a terephthalic acid intermediate). However, current processes for hydrogenation of muconic acid to form industrially relevant synthetic intermediates such as 3-hexene-1,6-dioic acid, 2-hexene-1,6-dioic acid, or adipic acid suffer from inefficiency, poor selectivity, and low yield.

### SUMMARY OF THE INVENTION

Various aspects of the present invention provide an electrocatalytic method to prepare 3-hexene-1,6-dioic acid, 2-hexene-1,6-dioic acid, adipic acid, or a combination thereof, from muconic acid. The method includes passing current through a catalytic cathode in a reactor including an aqueous solution including the muconic acid, a supporting electrolyte, and an anode, so as to hydrogenate the muconic acid to yield a product including 3-hexene-1,6-dioic acid, 2-hexene-1,6-dioic acid, adipic acid, or a mixture thereof. The aqueous solution has a pH of 5.5 to 14.

Various aspects of the present invention provide an electrocatalytic method to prepare adipic acid from muconic acid. The method includes passing current through a catalytic cathode including Pd on carbon, or Pt on carbon, or a combination thereof, wherein the Pd and Pt includes a surface (111) facet, wherein the catalytic cathode is in a reactor including an aqueous solution including the muconic acid, a supporting electrolyte, and an anode, so as to hydrogenate the muconic acid so as to yield a product including adipic acid with a selectivity of about 40% to about 100%.

Various aspects of the present invention provide an electrocatalytic method to prepare adipic acid from cis,cis-muconic acid. The method includes passing current through a catalytic cathode including Pd on carbon, or Pt on carbon, or a combination thereof, wherein the Pd and Pt includes a surface (111) facet, wherein the catalytic cathode is in a reactor including an aqueous solution including the cis,cis-muconic acid, a supporting electrolyte, and an anode, so as to hydrogenate the cis,cis-muconic acid so as to yield a product including adipic acid with a selectivity of about 40% to about 100%.

Various aspects of the present invention provide an electrocatalytic method to prepare adipic acid from muconic acid. The method includes passing current through a catalytic cathode including a material that includes a surface (111) facet, wherein the catalytic cathode is in a reactor including an aqueous solution including the muconic acid, a supporting electrolyte, and an anode, so as to hydrogenate the muconic acid so as to yield a product including adipic acid with a selectivity of about 40% to about 100%.

Various aspects of the present invention provide an electrocatalytic method to prepare adipic acid from cis,cis-muconic acid. The method includes passing current through a catalytic cathode including a material that includes a surface (111) facet, wherein the catalytic cathode is in a reactor including an aqueous solution including the cis,cis-muconic acid, a supporting electrolyte, and an anode, so as to hydrogenate the cis,cis-muconic acid so as to yield a product including adipic acid with a selectivity of about 40% to about 100%.

Various aspects of the present invention provide an electrocatalytic method to prepare trans-3-hexene-1,6-dioic acid from muconic acid. The method includes passing current through a cathode, wherein the cathode is in a reactor including an aqueous solution including muconic acid and having a pH of 5.5 to 14, a supporting electrolyte, and an anode, so as to hydrogenate the muconic acid to yield a product including trans-3-hexene-1,6-dioic acid with a selectivity of about 50% to about 100%.

Various aspects of the present invention provide an electrocatalytic method to prepare 3-hexene-1,6-dioic acid, 2-hexene-1,6-dioic acid, adipic acid, or a combination thereof, from muconic acid. The method includes passing current through a catalytic cathode in a reactor including an aqueous solution including the muconic acid, a supporting electrolyte, and an anode, so as to hydrogenate the muconic acid to yield a product including 3-hexene-1,6-dioic acid, 2-hexene-1,6-dioic acid, adipic acid, or a mixture thereof, wherein the aqueous solution includes a fermentation broth including the muconic acid and including one or more catalyst poisons. The method includes removing at least some of the one or more catalyst poisons from the catalytic cathode, to form a rejuvenated catalytic cathode. The method also includes reusing the rejuvenated catalytic cathode as the catalytic cathode in the method.

Various aspects of the present invention provide an electrocatalytic method that includes passing current through a catalytic cathode in a reactor including an aqueous solution including an organic substrate, a supporting electrolyte, and an anode, so as to electrocatalytically convert the organic substrate, wherein the aqueous solution includes a fermentation broth including the organic substrate and including one or more catalyst poisons that reduce catalytic activity of the catalytic cathode. The method includes removing one or more catalyst poisons from the catalytic cathode to form a rejuvenated catalytic cathode. The method also includes reusing the rejuvenated catalytic cathode in the method.

Various aspects of the present invention provide an electrocatalytic hydrogenation method that includes passing current through a catalytic cathode in a reactor including an aqueous solution including an unsaturated organic compound, a supporting electrolyte, and an anode, so as to hydrogenate the unsaturated organic compound, wherein the aqueous solution includes a fermentation broth including the unsaturated organic compound and including one or more catalyst poisons. The method includes removing one or more catalyst poisons from the catalytic cathode to form a rejuvenated catalytic cathode. The method also includes reusing the rejuvenated catalytic cathode in the method.

Various aspects of the present invention provide an electrocatalytic hydrogenation method to prepare 3-hexene-1,6-dioic acid, 2-hexene-1,6-dioic acid, adipic acid, or a combination thereof, from muconic acid. The method includes passing current through a catalytic cathode in a reactor including an aqueous solution including the muconic acid, a supporting electrolyte, and an anode, so as to hydrogenate the muconic acid to yield a product including 3-hexene-1,6-dioic acid, 2-hexene-1,6-dioic acid, adipic acid, or a mixture thereof, wherein the aqueous solution includes a fermentation broth including the muconic acid and including one or more catalyst poisons. The method includes removing one or more catalyst poisons from the catalytic cathode to form a rejuvenated catalytic cathode. The method also includes reusing the rejuvenated catalytic cathode as the catalytic cathode in the method.

Various aspects of the present invention have certain advantages over other methods of hydrogenating muconic acid. For example, in various aspects, hydrogen and catalyst can be used more efficiently, thus requiring lower catalyst loading of the reactor. In various aspects, there is little free hydrogenation gas present, thus reducing the risk of explosion and fire. In various aspects, the concentration of hydrogen on the catalyst metal surface can be easily controlled by adjusting the applied current (or applied electric potential), which can lead to improved product selectivity. In various aspects, the operating temperatures can be low, thus minimizing or reducing thermal degradation of the reactants and products or minimizing or reducing unwanted homogeneous side reactions. In various aspects, corrosion of the metal catalyst can be less, thus reducing or eliminating the presence of metal ion contaminants in the hydrogenated product.

In various aspects, the method can form 3-hexenedioic acid from muconic acid, such as trans-3-hexenedioic acid, with higher selectivity, higher conversion, or a combination thereof, as compared to other methods. In various aspects, the method can form adipic acid from muconic acid with higher selectivity, higher conversion, or a combination thereof, as compared to other methods. In various aspects, catalytic cathodes including a surface (111) facet, such as Pt or Pd including a surface (111) facet, or other materials including a surface (111) facet, can provide high selectivity for formation of adipic acid. In various aspects, materials that do not normally provide catalytic selectivity for adipic acid can have surface (111) facets formed thereon to provide a material having a surface (111) facet that does provide catalytic selectivity for adipic acid.

In some aspects, the method can include at least partially simultaneously forming muconic acid from microbial fermentation and performing electrocatalytic hydrogenation on the muconic acid directly in the fermentation broth, such that the microbe (e.g., yeast and/or bacteria) survives during the electrocatalytic hydrogenation and continues to generate muconic acid. In some aspects, the metal in the cathode can be less sensitive to impurities in the aqueous media as compared to other methods of hydrogenation, or can have no sensitivity to such impurities, such as compounds formed in the fermentation broth during the production of muconic acid, allowing the electrocatalytic hydrogenation method to be performed using impure aqueous media or using the fermentation broth. In various aspects, one or more catalyst poisons in the fermentation broth can be removed from the catalytic cathode to form a rejuvenated catalytic cathode that can be reused in the method with similar catalytic activity or the same catalytic activity as the unused catalytic cathode. In various aspects, the fermentation broth can include bacteria such as E. coli bacteria, such as metabolically-engineered E. coli bacteria, or P. putida bacteria.

In various aspects, the only byproducts of the method are H₂ and O₂. The H₂ produced by the reaction can be considered as “green” H₂.

In some aspects, hydrogenated products of the electrocatalytic hydrogenation can be polymerized. In various aspects, the polymer formed can have useful properties.

In various aspects, the method can be performed at neutral or near-neutral pH, avoiding addition of acids, and providing greater solubility of the muconic acid starting material. By providing a greater solubility of the muconic acid starting material, the method can more efficiently produce hydrogenation products than acidic methods with lower solubility of the muconic acid. In various aspects, performing the muconic acid hydrogenation at neutral or near-neutral pH can provide decreased hydrogen evolution, and can be more easily integrated with industrial processes that provide a muconic acid-containing fermentation broth at neutral or near-neutral pH.

### BRIEF DESCRIPTION OF THE FIGURES

The drawings illustrate generally, by way of example, but not by way of limitation, various aspects of the present invention.

FIG. 1 is a schematic drawing of a three-electrode electrochemical cell (1), according to various aspects of the present disclosure.

FIGS. 2A-2D illustrate concentration of reactants and products in solution after 1 hour of chronoamperometry experiments performed at varying working potentials (E_{we}) on (2A) Pt foil, (2B) Pt/C, (2C) Pd foil, and (2D) Pd/C, according to various aspects of the present disclosure.

FIGS. 2E-2F illustrate concentration of reactants and products in solution during chronoamperometry experiments performed for 1 h at −0.4 V_{Ag/AgCl} on 10 mg of (2E) Pd/C, and (2F) Pt/C, according to various aspects of the present disclosure.

FIG. 3A illustrates X-ray diffractograms of Pd/C, Pd foil, Pt/C, and Pt foil before reaction, according to various aspects of the present disclosure.

FIG. 3B illustrates HR-TEM images of fresh and spent Pd/C catalyst sample, according to various aspects of the present disclosure.

FIG. 3C illustrates concentration of reactants and products in solution during chronopotentiometry experiments performed for 1 h on Pd foil (left) and Pd/C (right), according to various aspects of the present disclosure.

FIGS. 4A-F illustrate concentration of reactants and products in solution as a function of time during chronoamperometry experiments performed at varying working potentials (E_{we}) on 10 mg of Pd/C (4A, 4B, and 4C) and on 10 mg of Pt/C (4D, 4E, 4F), according to various aspects of the present disclosure.

FIG. 5A illustrates concentration of reactants and products in solution after 1 h of chronoamperometry experiments performed at −0.7VAg/AgCl with 0.1 M of various supporting electrolytes, according to various aspects of the present disclosure.

FIGS. 5B-C illustrate concentration of reactants and products in solution during chronoamperometry experiments performed for 1 h using (5B) 10 mg of Pd/C deposited on carbon felt, and (5C) 10 mg of Pd/C deposited on carbon tape, according to various aspects of the present disclosure.

FIG. 6 illustrates DFT-calculated binding energy of trans-2-hexenedioic acid (BE_{t2HDA}, eV) as a function of the d-band center of Pd (ε_{d}−ε_{fermi}, eV), according to various aspects of the present disclosure.

FIG. 7 illustrates a cyclic voltammogram of cysteine-induced poisoning and electrochemical regeneration of platinum catalyst in a hydrogen evolution reaction (HER) using 0.1 M H₂SO₄ as an electrolyte, according to various aspects of the present disclosure.

FIG. 8 illustrates XPS spectra illustrating platinum surface changes due to cysteine poisoning and subsequent electrochemical regeneration in a HER using 0.1 M H₂SO₄ as an electrolyte, according to various aspects of the present disclosure.

FIG. 9 illustrate concentration versus time for conversion of cis, cis-muconic acid (ccMA) to AA on Pt-dep-Pt foil at −1.5 V over a duration of 4 h in a batch reactor setup, according to various aspects of the present disclosure.

FIG. 10A illustrates cyclic voltammograms showing the effect of cysteine poisoning and subsequent electrochemical regeneration of platinum (Pt) catalytic activity for the hydrogen evolution reaction (HER) in 0.1 M H₂SO₄, according to various aspects of the present disclosure.

FIG. 10B illustrates quantified hydrogen underpotential deposition (H_{UPD}) charge densities (μC/cm²) corresponding to pristine Pt, poisoned Pt, and regenerated Pt, plotted for 100 CV cycles, according to various aspects of the present disclosure.

FIG. 11 illustrates XPS survey spectra for five stages: (a) clean Pt, (b) CV-cycled in 0.1 M H₂SO₄, (c) poisoned with 1000 ppm cysteine, (d) electrochemically regenerated in fresh H₂SO₄ solution, and (e) pure cysteine, according to various aspects of the present disclosure.

FIG. 12A illustrates S 2p XPS spectra for blank Pt cycled in 0.1 M H₂SO₄, according to various aspects of the present disclosure.

FIG. 12B illustrates S 2p XPS spectra for Pt after poisoning with 1000 ppm cysteine, according to various aspects of the present disclosure.

FIG. 12C illustrates S 2p XPS spectra for Pt after electrochemical regeneration, according to various aspects of the present disclosure.

FIG. 12D illustrates S 2p XPS spectra for reference cysteine powder, according to various aspects of the present disclosure.

FIG. 13 illustrates hydrogen production as quantified from the H_{UPD} region of Pt CVs for four stages: (1) in blank 0.1 M H₂SO₄, representing the pristine benchmark; (2) after poisoning with 1000 ppm cysteine, showing significant activity loss; (3) after electrochemical regeneration via CV cycling in fresh electrolyte; and (4) after reductive stripping performed by CA in 0.1 V steps from −0.2 V to −1.2 V, illustrating full restoration of catalytic activity, according to various aspects of the present disclosure.

FIG. 14A illustrates remaining catalytic activity (quantified via H_{UPD} charge) after poisoning of Pt with different biogenic impurities, according to various aspects of the present disclosure.

FIG. 14B illustrates extent of catalytic activity recovery following electrochemical regeneration through reductive stripping (RS=reductive stripping), according to various aspects of the present disclosure.

FIG. 15 illustrates ECH of 0.5 g/L ccMA in 0.1 M H₂SO₄, showing catalytic performance of Pt at −0.7 V for 6 hours at four stages, according to various aspects of the present disclosure.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain aspects there is no hydrocarbyl group.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some aspects, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some aspects, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some aspects, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The terms “halo,” “halogen,” or “halide” group, as used herein, by themselves or as part of another substituent, mean, unless otherwise stated, a fluorine, chlorine, bromine, or iodine atom.

The term “number-average molecular weight” (Mₙ) as used herein refers to the ordinary arithmetic mean of the molecular weight of individual molecules in a sample. It is defined as the total weight of all molecules in a sample divided by the total number of molecules in the sample. Experimentally, Mₙ is determined by analyzing a sample divided into molecular weight fractions of species i having nᵢ molecules of molecular weight Mi through the formula Mₙ=ΣMᵢnᵢ/Σnᵢ. The Mₙ can be measured by a variety of well-known methods including gel permeation chromatography, spectroscopic end group analysis, and osmometry. If unspecified, molecular weights of polymers given herein are number-average molecular weights.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

The term “solvent” as used herein refers to a liquid that can dissolve a solid, liquid, or gas. Non-limiting examples of solvents are silicones, organic compounds, water, alcohols, ionic liquids, and supercritical fluids.

As used herein, the term “polymer” refers to a molecule having at least one repeating unit and can include copolymers.

In various aspects, salts having a positively charged counterion can include any suitable positively charged counterion. For example, the counterion can be ammonium(NH₄⁺), or an alkali metal such as sodium (Na⁺), potassium (K⁺), or lithium (Li⁺). In some aspects, the counterion can have a positive charge greater than +1, which can in some aspects complex to multiple ionized groups, such as Zn²⁺, Al³⁺, or alkaline earth metals such as Ca²⁺ or Mg²⁺.

In various aspects, salts having a negatively charged counterion can include any suitable negatively charged counterion. For example, the counterion can be a halide, such as fluoride, chloride, iodide, or bromide. In other examples, the counterion can be nitrate, hydrogen sulfate, dihydrogen phosphate, bicarbonate, nitrite, perchlorate, iodate, chlorate, bromate, chlorite, hypochlorite, hypobromite, cyanide, amide, cyanate, hydroxide, permanganate. The counterion can be a conjugate base of any carboxylic acid, such as acetate or formate. In some aspects, a counterion can have a negative charge greater than −1, which can in some aspects complex to multiple ionized groups, such as oxide, sulfide, nitride, arsenate, phosphate, arsenite, hydrogen phosphate, sulfate, thiosulfate, sulfite, carbonate, chromate, dichromate, peroxide, or oxalate.

The polymers described herein can terminate in any suitable way. In some aspects, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

### Method of Electrocatalytically Hydrogenating Muconic Acid.

In various embodiments, the present invention provides an electrocatalytic method to hydrogenate muconic acid to yield a product including the hydrogenated product 3-hexene-1,6-dioic acid, 2-hexene-1,6-dioic acid, adipic acid, or combinations thereof, with both a high conversion of muconic acid to the hydrogenated products and a high selectivity for conversion to one or more of the hydrogenated products. 3-Hexene-1,6-dioic acid or 2-hexene-1,6-dioic acid can be useful in preparing nylon 6,6 analogs (e.g., which can be designated as bio-based unsaturated nylon 6,6 analog or unsaturated polyamide (UPA) 6,6) with unique or adjustable properties. Furthermore, the unsaturated bond at the 2- or 3-position can be functionalized before or after copolymerization.

In various embodiments, the present invention provides an electrocatalytic method to prepare 3-hexene-1,6-dioic acid, 2-hexene-1,6-dioic acid, adipic acid, or a combination thereof, from muconic acid. The method can include passing current through a catalytic cathode in a reactor including an aqueous solution including muconic acid, a supporting electrolyte, and an anode, so as to hydrogenate the muconic acid to yield a product including 3-hexene-1,6-dioic acid, 2-hexene-1,6-dioic acid, adipic acid, or a mixture thereof. The form of the muconic acid in the aqueous solution can be consistent with the pH of the aqueous solution. For example, at basic, neutral, or near-neutral pH, the muconic acid can be in a deprotonated state as a muconate salt, or at acidic pH, the muconic acid can be in the form of an acid.

Hydrogen can be generated on the catalyst surface by the electrochemical reduction of protons or water in the electrolyte. The adsorbed hydrogen on the surface of the catalyst can react with the muconic acid to yield the saturated product (adipic acid) or partially saturated product (3-hexene-1,6-dioic acid or 2-hexene-1,6-dioic acid, with cis or trans configurations possible for both) as shown in Scheme 2. Alternatively or additionally, at lower pH, proton-coupled electron transfer (PCET) can occur, wherein organic radicals are generated near the cathode surface that further react with hydronium molecules and water molecules of the aqueous solution in a manner that yields a product.

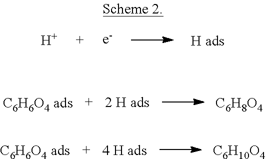

Since hydrogen is generated in situ directly on the catalyst surface or via PCET by passing current through the conductive catalyst, high operating temperatures and pressures are not required. The hydrogenation can be carried out at any suitable temperature and pressure. The hydrogenation can be conducted under ambient conditions of temperature and pressure, such as about 200 to about 30° C. and at about 1 atm, for a time sufficient to complete the desired transformation, e.g., about 0.5 h to about 24 h, about 1 h to about 5 h, or about 1 h or less, or less than, equal to, or greater than about 2 h, 3, 4, 5, 6, 7, 8, 9, 10, 11, 12, 13, 14, 15, 16, 17, 18, 19, 20, 21, 22, 23, or about 24 h or more.

The hydrogenation can be carried out in an aqueous medium, such as water or a microbial fermentation broth (e.g., medium) employed to prepare the muconic acid. The aqueous medium can be an electrolyte. The aqueous medium can have any suitable pH. The aqueous medium can have a pH of 0.5 to 14, or 0.5 to 8, or equal to or greater than 0.5 and less than or equal to 14 and less than, equal to, or greater than 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, or 13.5. In various aspects, the medium can have a pH that is neutral or near-neutral, such as a pH of 5.5 to 8, or 6 to 7.5, or 6.5 to 7.5, or about 7. The medium can have a pH that is greater than or equal to 5.5 and less than or equal to 8 and less than, equal to, or greater than 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, or 7.9. In various aspects, the aqueous medium having a pH that is neutral or near-neutral can advantageously provide greater solubility of the muconic acid in the aqueous medium, allowing a larger amount of muconic acid to be dissolved in the same volume of aqueous medium. For example, the aqueous medium can have a pH of 5.5 to 14 or 5.5 to 8 and can include a concentration of the muconic acid of 0.01 g/L to 150 g/L, or at least 10 g/L, or at least 50 g/L, or greater than or equal to 0.01 g/L and less than or equal to 150 g/L and less than, equal to, or greater than 0.5 g/L, 1, 5, 10, 15, 20, 25, 30, 35, 40, 45, 50, 55, 60, 65, 70, 75, 80, 85, 90, 95, 100, 105, 110, 115, 120, 125, 130, 135, 140, or 145 g/L. In comparison, an aqueous solution with a pH of 1 to 3 can have a maximum solubility of muconic acid of about 1 g/L. In various aspects, the aqueous medium can include a buffer, such as a phosphate buffer. In various aspects, a buffer can maintain the muconic acid in a deprotonated state during the electrocatalytic hydrogenation thereof.

The aqueous medium can include an inorganic or organic acid, such as formic acid, sulfuric acid, a salt thereof (e.g., that provides an electrolyte), a salt (such as sulfates like ammonium sulfate, or phosphates), or a combination thereof. In some aspects, other than the muconic acid and hydrogenation products thereof, the aqueous solution can be substantially free of added acids, such as added organic acids or mineral acids or salts thereof; for example, added acid can be 0 wt % to 0.01 wt % of the aqueous solution, or less than 0.01 wt %, or less than 0.001 wt %, or 0 wt %. In various aspects, other than hydrogen generated on anode or cathode during the electrocatalytic hydrogenation, the aqueous solution can be substantially free of added H₂.

The aqueous medium can be contained in a reactor that includes an anode (e.g., the counter electrode), a cathode (e.g., the working electrode), and a reference electrode (e.g., an Ag/AgCl electrode or a reversible hydrogen electrode). The reactor can be any suitable reactor having any suitable shape, such that the method can be carried out as described herein. The reactor can be a batch reactor. The reactor can be a continuous flow reactor.

The muconic acid can be produced in any suitable way. In some embodiments, the muconic acid is commercially obtained. In some embodiments, the muconic acid is produced from petroleum materials. In some embodiments, the muconic acid is produced from a microorganism or an enzyme, such as any suitable microorganism or enzyme. The muconic acid can be produced by yeast or bacteria, such as any suitable yeast or bacteria. The microorganism (e.g., yeast or bacteria) or enzyme can use any suitable organic material to generate the muconic acid, such as a carbohydrate (e.g., glucose), or such as an aromatic material (e.g., lignin). In some embodiments, the muconic acid is generated by yeast and/or bacteria in a fermentation broth.

The fermentation broth can be any suitable fermentation broth. The fermentation broth can include glucose and support the conversion of glucose into muconic acid by yeast or bacteria, such as any suitable type of yeast or bacteria that can perform the conversion. The fermentation broth can include yeast nitrogen base. The yeast nitrogen base can be substantially free of amino acids, ammonium sulfate, or a combination thereof. The fermentation broth can include complete supplement mixture (CSM) uracil-dropout amino acid mix. The method can include at least partially simultaneously fermenting the broth to form muconic acid from the yeast and/or bacteria and hydrogenating muconic acid in the broth.

The cathode used in the reaction can utilize both high and low hydrogen overvoltage catalytic metals, e.g., a metal, lead, platinum, vanadium, chromium, manganese, iron, cobalt, zinc, aluminum, titanium, zirconium, niobium, molybdenum, ruthenium, palladium, cadmium, indium, samarium, antimony, hafnium, tantalum, rhenium, iridium, gold, bismuth, tungsten, nickel, copper, silver, carbon (e.g., graphite, reticulated vitreous carbon), alloys of any two or more of the same, leaded brass, or combinations thereof. The cathode can include Cu, Fe, Ni, Pd, Pt, Pd/C, Pb, Sn, Ti, Zn, C, Cd, V, Cr, Mn, Co, Al, Nb, Mo, Ru, In, Sm, Sb, Hf, Ta, Re, Ir, Au, Bi, W, Cu, Ag, Ga, Pd—Ga alloy, Pd—Au alloy, an alloy of any two or more of the same, leaded brass, or a combination thereof. The cathode can include a carbon support that supports the cathode material. The cathode can include Pd or Pt. The cathode can include Pd/C or Pt/C. The cathode can include a material that includes a surface (100) facet, (110) facet, (111) facet, or a combination thereof, such as any suitable material, or such as Pd including a surface (100) facet, (110) facet, (111) facet, or a combination thereof, or such as Pt including a surface (100) facet, (110) facet, (111) facet, or a combination thereof. The cathode can include a material that includes a surface (111) facet, such as any suitable material, or such as Pd including a surface (111) facet, or such as Pt including a surface (111) facet. In various aspects, materials that include a (111) can be selective for formation of adipic acid from muconic acid, such as for formation of adipic acid from cis,cis-muconic acid (ccMA).

The material used for the anode is not critical. Suitable anodes can include graphite, platinum, platinum-coated titanium, ruthenium oxide titanium oxide-coated titanium, or combinations thereof. The anodic reaction can be the oxidation of water to produce oxygen gas.

The electric potential applied to the cathode with respect to a reference electrode (e.g., an Ag/AgCl reference electrode or a reversible hydrogen electrode in the electrolyte solution with the anode and cathode) can be adjustable and can be maintained at about +0.1 V to about −5 V, or about +0.1 V to −5 V, or about −0.1 to about −5 V, about −0.5 to about −3.0 V, about −0.5 to about −2.0 V, e.g., about −0.8 to −1.8 V, or the beginning and ending voltage for a cycle can be greater than or equal to about −5 V and less than or equal to about +0.1 V and less than, equal to, or greater than about 0, −0.1, −0.2, −0.3, −0.4, −0.5, −0.6, −0.7, −0.8, −0.9, −1, −1.1, −1.2, −1.3, −1.4, −1.5, −1.6, −1.7, −1.8, −1.9, −2, −2.1, −2.2, −2.4, −2.6, −2.8, −3, −3.2, −3.4, −3.6, −3.8, −4, −4.2, −4.4, −4.6, of about −4.8 V. In some embodiments, under these conditions, nearly quantitative yields of the hexenedioic acid (HDA) can be obtained in less than 2 hrs.

The muconic acid starting material can be any suitable muconic acid. The muconic acid can be cis,cis-muconic acid, cis,trans-muconic acid, trans,trans-muconic acid, or a combination thereof. In various embodiments, the muconic acid starting material is about 0 mol % to about 100 mol % cis,cis-muconic acid, or about 0 mol %, or about 0.001 mol % or less, or less than, equal to, or more than about 0.01 mol %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 mol % or more, or about 100 mol %. In various embodiments, the muconic acid starting material is about 0 mol % to about 100 mol % cis,trans-muconic acid, or about 0 mol %, or about 0.001 mol % or less, or less than, equal to, or more than about 0.01 mol %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 mol % or more, or about 100 mol %. In various embodiments, the muconic acid starting material is about 0 mol % to about 100 mol % trans,trans-muconic acid, or about 0 mol %, or about 0.001 mol % or less, or less than, equal to, or more than about 0.01 mol %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 mol % or more, or about 100 mol %.

The electrocatalytic hydrogenation of the muconic acid can yield a product mixture that has any suitable composition. The product can include 3-hexene-1,6-dioic acid (e.g., cis-3-hexene-1,6-dioic acid, trans-3-hexene-1,6-dioic acid, or a combination thereof), 2-hexene-1,6-dioic acid (e.g. cis-3-hexene-1,6-dioic acid, trans-3-hexene-1,6-dioic acid, or a combination thereof), adipic acid, or a combination thereof. The acid products in the product mixture can be in any suitable form consistent with the pH of the product mixture. For example, at basic, neutral, or near-neutral pH, the acid product(s) can be deprotonated and can be in the form of a salt (e.g., cis-3-hexene-1,6-dioate, trans-3-hexene-1,6-dioate, or adipate), while at acidic pH, the acid can be in the form of the carboxylic acid.

The product of the electrocatalytic hydrogenation of the muconic acid can include 3-hexene-1,6-dioic acid (e.g., cis, trans, or a combination thereof) in any suitable wt % or mol %. For example, the product can be about 0 wt % to about 100 wt % 3-hexene-1,6-dioic acid, or about 0 wt %, or about 0.001 wt % or less, or less than, equal to, or more than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 wt % or more, or about 100 wt %. For example, the product can be about 0 mol % to about 100 mol % 3-hexene-1,6-dioic acid, or about 0 mol %, or about 0.001 mol % or less, or less than, equal to, or more than about 0.01 mol %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 mol % or more, or about 100 mol %. The electrocatalytic hydrogenation of the muconic acid can have any suitable selectivity for 3-hexene-1,6-dioic acid, such as about 0% to about 100% (e.g., 0 mol % to about 100 mol % of the muconic acid hydrogenated can be 3-hexene-1,6-dioic acid), or about 0%, or about 0.001% or less, or less than, equal to, or greater than about 0.01%, 0.1, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999% or more, or about 100%.

The product of the electrocatalytic hydrogenation of the muconic acid can include cis-3-hexene-1,6-dioic acid in any suitable wt % or mol %. For example, the product can be about 0 wt % to about 100 wt % cis-3-hexene-1,6-dioic acid, or about 0 wt %, or about 0.001 wt % or less, or less than, equal to, or more than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 wt % or more, or about 100 wt %. For example, the product can be about 0 mol % to about 100 mol % cis-3-hexene-1,6-dioic acid, or about 0 mol %, or about 0.001 mol % or less, or less than, equal to, or more than about 0.01 mol %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 mol % or more, or about 100 mol %. The electrocatalytic hydrogenation of the muconic acid can have any suitable selectivity for cis-3-hexene-1,6-dioic acid, such as about 0% to about 100%, or about 0%, or about 0.001% or less, or less than, equal to, or greater than about 0.01%, 0.1, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999% or more, or about 100%.

The product of the electrocatalytic hydrogenation of the muconic acid can include trans-3-hexene-1,6-dioic acid in any suitable wt % or mol %. For example, the product can be about 0 wt % to about 100 wt % trans-3-hexene-1,6-dioic acid, or about 0 wt %, or about 0.001 wt % or less, or less than, equal to, or more than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 wt % or more, or about 100 wt %. For example, the product can be about 0 mol % to about 100 mol % trans-3-hexene-1,6-dioic acid, or about 0 mol %, or about 0.001 mol % or less, or less than, equal to, or more than about 0.01 mol %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 mol % or more, or about 100 mol %. The electrocatalytic hydrogenation of the muconic acid can have any suitable selectivity for trans-3-hexene-1,6-dioic acid, such as about 0% to about 100%, or about 0%, or about 0.001% or less, or less than, equal to, or greater than about 0.01%, 0.1, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999% or more, or about 100%.

The product of the electrocatalytic hydrogenation of the muconic acid can include 2-hexene-1,6-dioic acid (e.g., cis, trans, or a combination thereof) in any suitable wt % or mol %. For example, the product can be about 0 wt % to about 100 wt % 2-hexene-1,6-dioic acid, or about 0 wt %, or about 0.001 wt % or less, or less than, equal to, or more than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 wt % or more, or about 100 wt %. For example, the product can be about 0 mol % to about 100 mol % 2-hexene-1,6-dioic acid, or about 0 mol %, or about 0.001 mol % or less, or less than, equal to, or more than about 0.01 mol %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 mol % or more, or about 100 mol %. The electrocatalytic hydrogenation of the muconic acid can have any suitable selectivity for 2-hexene-1,6-dioic acid, such as about 0% to about 100%, or about 0%, or about 0.001% or less, or less than, equal to, or greater than about 0.01%, 0.1, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999% or more, or about 100%.

The product of the electrocatalytic hydrogenation of the muconic acid can include cis-2-hexene-1,6-dioic acid in any suitable wt % or mol %. For example, the product can be about 0 wt % to about 100 wt % cis-2-hexene-1,6-dioic acid, or about 0 wt %, or about 0.001 wt % or less, or less than, equal to, or more than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 wt % or more, or about 100 wt %. For example, the product can be about 0 mol % to about 100 mol % cis-2-hexene-1,6-dioic acid, or about 0 mol %, or about 0.001 mol % or less, or less than, equal to, or more than about 0.01 mol %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 mol % or more, or about 100 mol %. The electrocatalytic hydrogenation of the muconic acid can have any suitable selectivity for cis-2-hexene-1,6-dioic acid, such as about 0% to about 100%, or about 0%, or about 0.001% or less, or less than, equal to, or greater than about 0.01%, 0.1, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999% or more, or about 100%.

The product of the electrocatalytic hydrogenation of the muconic acid can include trans-2-hexene-1,6-dioic acid in any suitable wt % or mol %. For example, the product can be about 0 wt % to about 100 wt % trans-2-hexene-1,6-dioic acid, or about 0 wt %, or about 0.001 wt % or less, or less than, equal to, or more than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 wt % or more, or about 100 wt %. For example, the product can be about 0 mol % to about 100 mol % trans-2-hexene-1,6-dioic acid, or about 0 mol %, or about 0.001 mol % or less, or less than, equal to, or more than about 0.01 mol %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 mol % or more, or about 100 mol %. The electrocatalytic hydrogenation of the muconic acid can have any suitable selectivity for trans-2-hexene-1,6-dioic acid, such as about 0% to about 100%, or about 0%, or about 0.001% or less, or less than, equal to, or greater than about 0.01%, 0.1, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999% or more, or about 100%.

The product of the electrocatalytic hydrogenation of the muconic acid can include adipic acid in any suitable wt % or mol %. For example, the product can be about 0 wt % to about 100 wt % adipic acid, or about 0 wt %, or about 0.001 wt % or less, or less than, equal to, or more than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 wt % or more, or about 100 wt %. For example, the product can be about 0 mol % to about 100 mol % adipic acid, or about 0 mol %, or about 0.001 mol % or less, or less than, equal to, or more than about 0.01 mol %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 mol % or more, or about 100 mol %. The electrocatalytic hydrogenation of the muconic acid can have any suitable selectivity for adipic acid, such as about 0% to about 100%, or about 0%, or about 0.001% or less, or less than, equal to, or greater than about 0.01%, 0.1, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999% or more, or about 100%. In various aspects, muconic acid can first be electrochemically hydrogenated to trans-3-HDA or trans-2-HDA near the carbon support (e.g., electron transfer), then trans-3-HDA/trans-2-HDA could get further electrocatalytically hydrogenated to adipic acid on the catalytic cathode (e.g., Pd or Pd/C).

The electrocatalytic hydrogenation of the muconic acid can be performed with any suitable percent conversion of the muconic acid. For example, the conversion of the muconic acid can be about 0.001% to about 100%, or about 0.001% or less, or less than, equal to, or greater than, about 0.01%, 0.1, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999% or more, or about 100%.

The cathode can include any suitable material, such that the method can be carried out as described herein. The cathode can include, or can be, one or more transition metals. The cathode can include, or can be, at least one of Cu, Fe, Ni, Pd, Pt, Pd/C, Pb, Sn, Ti, Zn, C, Cd, V, Cr, Mn, Co, Al, Nb, Mo, Ru, In, Sm, Sb, Hf, Ta, Re, Ir, Au, Bi, W, Cu, Ag, Ga, Pd—Ga alloy, Pd—Au alloy, an alloy of any two or more of the same, leaded brass, or a combination thereof. The cathode can include, or can be, at least one of Cu, Fe, Ni, Pd, Pt, Pd/C, Pb, Sn, Ti, Zn, or a combination thereof. The cathode can include, or can be, one or more platinum group metals. The cathode can include, or can be, lead. The cathode can include, or can be, platinum. The cathode can include, or can be, palladium.

In various aspects, the cathode is or includes a material that includes a (100) facet, (110) facet, (111) facet, or a combination thereof, at its surface (e.g., external exposed surface), and/or a (100), (110), (111), or combination thereof, surface structure corresponding to face centered cubic (FCC) or FCC-like geometries. Whether a material includes a (100) facet, (110) facet, (111) facet, or a combination thereof at its surface can be experimentally verified using X-ray diffraction. The cathode can include Pd including a surface (100) facet, (110) facet, (111) facet, or a combination thereof, or Pt including a surface (100) facet, (110) facet, (111) facet, or a combination thereof. In various aspects, the cathode includes Pd including a (100) facet, (110) facet, (111) facet, or a combination thereof, at its surface, wherein the Pd is on carbon (e.g., Pd/C). In various aspects, the cathode includes Pt including a (100) facet, (110) facet, (111) facet, or a combination thereof, at its surface, wherein the Pt is on carbon (e.g., Pt/C). In various aspects, the material including a (100) facet, (110) facet, (111) facet, or a combination thereof, at its surface naturally includes the (100) facet, (110) facet, (111) facet, or a combination thereof, at its surface and does not require any synthetic modification to generate the surface (100) facet, (110) facet, (111) facet, or a combination thereof. In various aspects, the material including a (100) facet, (110) facet, (111) facet, or a combination thereof, at its surface is a material that does not naturally include a surface (100) facet, (110) facet, (111) facet, or a combination thereof, and one or more surface (100) facet, (110) facet, (111) facet, or a combination thereof, are synthetically deposited on the material to form the material including a surface (100) facet, (110) facet, (111) facet, or a combination thereof. The material having a surface (100) facet, (110) facet, (111) facet, or a combination thereof, synthetically deposited thereon can include Cu, Fe, Ni, Pd, Pt, Pd/C, Pb, Sn, Ti, Zn, C, Cd, V, Cr, Mn, Co, Al, Nb, Mo, Ru, In, Sm, Sb, Hf, Ta, Re, Ir, Au, Bi, W, Cu, Ag, Ga, silicon carbide, an oxide (e.g., silica, alumina), Sn, Pd—Ga alloy, Pd—Au alloy, a Pd hydride, an alloy of any two or more of the same, leaded brass, any of these materials under compressive strain, or a combination thereof.

In various aspects, the cathode is or includes a material that includes a (111) facet at its surface (e.g., external exposed surface), and/or a (111) surface structure corresponding to face centered cubic (FCC) or FCC-like geometries. Whether a material includes a (111) facet at its surface can be experimentally verified using X-ray diffraction. The cathode can include Pd including a surface (111) facet, or Pt including a surface (111) facet. In various aspects, the cathode includes Pd including a (111) facet at its surface, wherein the Pd is on carbon (e.g., Pd/C). In various aspects, the cathode includes Pt including a (111) facet at its surface, wherein the Pt is on carbon (e.g., Pt/C). In various aspects, the material including a (111) facet at its surface naturally includes the (111) facet at its surface and does not require any synthetic modification to generate the surface (111) facet. In various aspects, the material including a (111) facet at its surface is a material that does not naturally include a surface (111) facet, and one or more surface (111) facets are synthetically deposited on the material to form the material including a surface (111) facet. The material having a surface (111) facet synthetically deposited thereon can include Cu, Fe, Ni, Pd, Pt, Pd/C, Pb, Sn, Ti, Zn, C, Cd, V, Cr, Mn, Co, Al, Nb, Mo, Ru, In, Sm, Sb, Hf, Ta, Re, Ir, Au, Bi, W, Cu, Ag, Ga, silicon carbide, an oxide (e.g., silica, alumina), Sn, Pd—Ga alloy, Pd—Au alloy, a Pd hydride, an alloy of any two or more of the same, leaded brass, any of these materials under compressive strain, or a combination thereof. In various aspects, cathode materials that include a surface (111) facet are selective for forming adipic acid from muconic acid, such as for forming adipic acid from ccMA. The adipic acid can be formed with any suitable selectivity, such as about 80% to about 100%, or about 90% to about 100%, or about 95% to about 100%, or about 80% or less, or less than, equal to, or greater than about 81%, 82, 83, 84, 85, 86, 87, 88, 89, 90, 91, 92, 93, 94, 95, 96, 97, 98, 99, 99.9, 99.99, or about 99.999% or more, or about 100%.

In various embodiments, the cathode can include, or can be, Ni, Pd (e.g., Pd foil or Pd on C), Pt, or a combination thereof. The electrocatalytic hydrogenation can yield a product that includes adipic acid. The adipic acid can be formed with any suitable selectivity, such as about 80% to about 100%, or about 90% to about 100%, or about 95% to about 100%, or about 80% or less, or less than, equal to, or greater than about 81%, 82, 83, 84, 85, 86, 87, 88, 89, 90, 91, 92, 93, 94, 95, 96, 97, 98, 99, 99.9, 99.99, or about 99.999% or more, or about 100%.

In various embodiments, the cathode can include at least one of Cu, Fe, Ni, Pd, Pt, Pd/C, Pb, Sn, Ti, Zn, C, Cd, V, Cr, Mn, Co, Al, Nb, Mo, Ru, In, Sm, Sb, Hf, Ta, Re, Ir, Au, Bi, W, Cu, Ag, Ga, Pd—Ga alloy, Pd—Au alloy, an alloy of any two or more of the same, leaded brass, or a combination thereof. In various embodiments, the cathode can include Cu, Fe, Pb, Sn, Ti, Zn, or a combination thereof. The cathode can include or can be Pb. The electrocatalytic hydrogenation can yield a product that includes trans-3-hexene-1,6-dioic acid. The trans-3-hexene-1,6-dioic acid can be formed with any suitable selectivity, such as about 40% to about 100%, about 80% to about 100%, or about 90% to about 100%, or about 95% to about 100%, or about 40% or less, or less than, equal to, or greater than about 45, 50, 55, 60, 65, 70, 75, 80, 81%, 82, 83, 84, 85, 86, 87, 88, 89, 90, 91, 92, 93, 94, 95, 96, 97, 98, 99, 99.9, 99.99, or about 99.999% or more, or about 100%. The muconic acid can be converted with any suitable percent conversion, such as about 40% to about 100%, about 80% to about 100%, or about 90% to about 100%, or about 95% to about 100%, or about 40% or less, or less than, equal to, or greater than about 45, 50, 55, 60, 65, 70, 75, 80, 81%, 82, 83, 84, 85, 86, 87, 88, 89, 90, 91, 92, 93, 94, 95, 96, 97, 98, 99, 99.9, 99.99, or about 99.999% or more, or about 100%.

The electrocatalytic hydrogenation of the muconic acid can occur with any suitable faradaic efficiency, such as about 2% to about 100%, or about 30% to about 100%, or about 2% or less, or less than, equal to, or greater than about 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 25, 30, 35, 40, 45, 50, 55, 60, 65, 70, 75, 80, 81, 82, 83, 84, 85, 86, 87, 88, 89, 90, 91, 92, 93, 94, 95, 96, 97, 98, 99, 99.9, 99.99, or about 99.999% or more, or about 100%.

During the electrocatalytic hydrogenation the cathode can have any suitable catalytic turnover frequency, such as about 0.01 s⁻¹ to about 120 s⁻¹, about 0.01 s⁻¹ to about 60 s⁻¹, about 0.10 s⁻¹ to about 35 s⁻¹, or about 0.01 s⁻¹ or less, or less than, equal to, or more than about 0.1 s⁻¹, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, 6.5, 7, 7.5, 8, 8.5, 9, 9.5, 10, 11, 12, 13, 14, 15, 16, 17, 18, 19, 20, 25, 30, 35, 40, 45, 50, 55, or about 60 s⁻¹ or more.

A fermentation broth used to generate the muconic acid can be used as all or a portion of the aqueous medium in which the electrocatalytic hydrogenation is performed. In various aspects, the fermentation broth can include one or more materials that poison the catalyst during the electrocatalytic hydrogenation and that decrease the catalytic activity of the catalyst, such as one or more amino acids. For example, the fermentation broth can include one or more catalyst poisons including methionine, cysteine, tryptophan, glutamic acid, alanine, proteose peptone, or a combination thereof. In various aspects, the method can include removing one or more catalyst poisons from the catalyst to partially or fully restore the catalytic activity thereof. Removing the one or more catalyst poisons can include any suitable removal method, such as applying a constant negative potential or an alternating potential (switching from negative potential to 0 V or switching between negative and positive potential) to the cathode to strip away the poisons and rejuvenate the catalyst. This treatment can be effective both under either acidic or pH neutral conditions. In some embodiments, the removal of the one or more catalyst poisons can include scanning the potential in the range of 1.5 V to 2.0 V vs Ag/AgCl (Saturated KCl), or with beginning and ending voltages of a cycle in the range of −5 V to +5 V or −5 V to +2 V. Removing the one or more catalyst poisons can form a rejuvenated catalyst that has a catalytic activity for the electrocatalytic hydrogenation that is 10% to 100% of the original catalytic activity prior to the poisoning, or 50% to 100%, or 80% to 100%, or less than or equal to 100% and greater than or equal to 10% and less than, equal to, or greater than 20%, 25, 30, 35, 40, 45, 50, 55, 60, 65, 70, 75, 80, 82, 84, 86, 88, 90, 91, 92, 93, 94, 95, 96, 97, 98, or 99%. In various aspects, the catalyst that is rejuvenated and reused can include a surface (100) facet, (110) facet, (111) facet, or a combination thereof, such as Pd including a (100) facet, (110) facet, (111) facet, or a combination thereof, at its surface or Pt including a (100) facet, (110) facet, (111) facet, or a combination thereof, at its surface.

The fermentation broth can include a synthetic fermentation medium containing macro-nutrients and micro-nutrients. The macro-nutrients can include any suitable one or more macro-nutrients, such as citric acid monohydrate (C₆H₈O₇·H₂O), ferric citrate (C₆H₅FeO₇), magnesium sulfate anhydrous (MgSO₄), calcium chloride anhydrous (CaCl₂), 4-aminobenzoic acid (C₇H₇NO₂), 4-hydroxybenzoic acid (C₇H₆O₃), glucose, or a combination thereof. The micro-nutrients can include any suitable one or more micro-nutrients, such as ferric chloride hexahydrate (FeCl₃·6H₂O), cobalt (II) chloride hexahydrate (CoCl₂·6H₂O), zinc chloride (ZnCl₂), sodium molybdate dihydrate (Na₂MoO₄·2H₂O), boric acid (H₃BO₃), manganese chloride tetrahydrate (MnCl₂·4H₂O), copper (II) chloride (CuCl₂), or a combination thereof. The one or more catalyst poisons in the fermentation broth can include a sulfur-containing amino acid, a nitrogen-containing amino acid, a peptide, a protein, a vitamin, an organic acid, a salt, or a combination thereof. The sulfur-containing amino acid can include cysteine, methionine, or a combination thereof. The nitrogen-containing amino acid can include tryptophan, and the one or more catalyst poisons in the fermentation broth can optionally include alanine, glutamic acid, glycine, or a combination thereof. The peptide can include glutathione, proteose peptone, or a combination thereof. The removing of the one or more catalyst poisons can include applying a reductive stripping potential to the catalytic cathode. The reductive stripping potential can be about −0.9 V to about −1.9 V versus Ag/AgCl, or about −1.1 V to about −1.4 V versus Ag/AgCl. The removing of the one or more catalyst poisons can include cyclic voltammetry in a fresh electrolyte solution substantially free of the one or more catalyst poisons. The fresh electrolyte solution can include an acid, such as H₂SO₄, e.g., 0.1 M H₂SO₄. The removing of the one or more catalyst poisons can include performing chronoamperometry at a constant reductive potential for about 10 minutes to about 60 minutes, or for about 30 minutes. The catalytic cathode can include a material including a (100) facet, (110) facet, (111) facet, or a combination thereof, at its surface selected from the group consisting of Pd, Pt, Pd/C, Pt/C, or a combination thereof. The catalytic cathode can include platinum electrodeposited on a platinum substrate to form Pt(111)-rich surfaces.

The one or more catalyst poisons can reduce catalytic activity of the catalytic cathode by about 50% to about 95% compared to a pristine cathode, or by about 80% to about 90%. The rejuvenated catalytic cathode can have a catalytic activity that is about 80% to about 100% of an original catalytic activity prior to poisoning, or about 95% to about 100% of the original catalytic activity. The catalytic activity can be assessed by hydrogen underpotential deposition (H_{UPD}) charge density measurements. The method can include analyzing the surface of the catalytic cathode to confirm removal of surface-bound species by a technique selected from the group consisting of X-ray photoelectron spectroscopy (XPS), cyclic voltammetry, or a combination thereof.

The method can include achieving complete or substantially complete conversion of the muconic acid after one or more cycles of poisoning and electrochemical regeneration. The electrochemical regeneration can restore the catalytic activity to a level sufficient to achieve at least 80% conversion of muconic acid to adipic acid (e.g., greater than or equal to 80% and less than or equal to 100% and less than, equal to, or greater than 81%, 82, 83, 84, 85, 86, 87, 88, 89, 90, 91, 92, 93, 94, 95, 96, 97, 98, or 99%). The method can include monitoring the catalytic activity of the catalytic cathode and initiating electrochemical regeneration when a decrease in activity is detected. The method can include sequentially or simultaneously performing electrocatalytic hydrogenation and electrochemical regeneration of the catalytic cathode, thereby enabling continuous or semi-continuous operation. The method can be performed in a fermentation broth including a mixture of biogenic impurities, and wherein the electrochemical regeneration can restore the catalytic activity of the cathode to a level sufficient to achieve at least 80% conversion of muconic acid to adipic acid (e.g., greater than or equal to 80% and less than or equal to 100% and less than, equal to, or greater than 81%, 82, 83, 84, 85, 86, 87, 88, 89, 90, 91, 92, 93, 94, 95, 96, 97, 98, or 99%).

### Electrocatalytic Method Including Rejuvenating and Reusing Catalytic Cathode.

Various aspects of the present invention provide an electrocatalytic method including passing current through a catalytic cathode in a reactor including an aqueous solution including an organic substrate, a supporting electrolyte, and an anode, so as to electrocatalytically convert the organic substrate, wherein the aqueous solution includes a fermentation broth including the organic substrate and including one or more catalyst poisons that reduce catalytic activity of the catalytic cathode. The method can include removing one or more catalyst poisons from the catalytic cathode to form a rejuvenated catalytic cathode. The method can also include reusing the rejuvenated catalytic cathode in the method. The electrocatalytic conversion can be any suitable electrocatalytic conversion. The electrocatalytically converting can include hydrogenating an unsaturated organic compound, wherein the organic substrate includes the unsaturated organic compound. The unsaturated organic compound can be any suitable unsaturated organic compound. The unsaturated organic compound can include muconic acid, and wherein the hydrogenating yields a product including 3-hexene-1,6-dioic acid, 2-hexene-1,6-dioic acid, adipic acid, or a mixture thereof.

The fermentation broth can include a synthetic fermentation medium containing macro-nutrients and micro-nutrients. The one or more catalyst poisons in the fermentation broth can include a sulfur-containing amino acid, a nitrogen-containing amino acid, a peptide, a protein, a vitamin, an organic acid, a salt, or a combination thereof. The sulfur-containing amino acid can include cysteine, methionine, or a combination thereof. The nitrogen-containing amino acid can include tryptophan, and the one or more catalyst poisons can optionally include alanine, glutamic acid, glycine, or a combination thereof. The peptide can include glutathione, proteose peptone, or a combination thereof. The removing of the one or more catalyst poisons can include applying a reductive stripping potential to the catalytic cathode. The reductive stripping potential can be about −0.9 V to about −1.9 V versus Ag/AgCl, or about −1.1 V to about −1.4 V versus Ag/AgCl. The removing of the one or more catalyst poisons can include cyclic voltammetry in a fresh electrolyte solution substantially free of the one or more catalyst poisons. The fresh electrolyte solution can include an acid, such as H₂SO₄, e.g., 0.1 M H₂SO₄. The removing of the one or more catalyst poisons can include performing chronoamperometry at a constant reductive potential for about 10 minutes to about 60 minutes, or for about 30 minutes. The catalytic cathode can include a material including a (100) facet, (110) facet, (111) facet, or a combination thereof, at its surface selected from the group consisting of Pd, Pt, Pd/C, Pt/C, or a combination thereof. The catalytic cathode can include platinum electrodeposited on a platinum substrate to form Pt(111)-rich surfaces.

The one or more catalyst poisons can reduce catalytic activity of the catalytic cathode by about 50% to about 95% compared to a pristine cathode, or by about 80% to about 90%. The rejuvenated catalytic cathode can have a catalytic activity that is about 80% to about 100% of an original catalytic activity prior to poisoning, or about 95% to about 100% of the original catalytic activity. The catalytic activity can be assessed by hydrogen underpotential deposition (H_{UPD}) charge density measurements. The method can include analyzing the surface of the catalytic cathode to confirm removal of surface-bound species by a technique selected from the group consisting of X-ray photoelectron spectroscopy (XPS), cyclic voltammetry, or a combination thereof.

The method can include achieving complete or substantially complete conversion of the muconic acid after one or more cycles of poisoning and electrochemical regeneration. The electrochemical regeneration can restore the catalytic activity to a level sufficient to achieve at least 80% conversion of muconic acid to adipic acid. The method can include monitoring the catalytic activity of the catalytic cathode and initiating electrochemical regeneration when a decrease in activity is detected. The method can include sequentially or simultaneously performing electrocatalytic hydrogenation and electrochemical regeneration of the catalytic cathode, thereby enabling continuous or semi-continuous operation. The method can be performed in a fermentation broth including a mixture of biogenic impurities, and wherein the electrochemical regeneration can restore the catalytic activity of the cathode to a level sufficient to achieve at least 80% conversion of muconic acid to adipic acid.

### Method of Making a Polymer.

In some embodiments, the method of electrocatalytically hydrogenating the muconic acid can be a method of making a polymer. After performing the electrocatalytic hydrogenation, the method can further include polymerizing one or more products of the hydrogenation of the muconic acid along with one or more other compounds to form a polymer. The polymer can have any suitable structure. The method of making a polymer can include performing an embodiment of the method of electrocatalytically hydrogenating muconic acid described herein to form 2-hexene-1,6-dioic acid, the 3-hexene-1,6-dioic acid, the adipic acid, or a combination thereof. The method can include polymerizing the 2-hexene-1,6-dioic acid, the 3-hexene-1,6-dioic acid, the adipic acid, or a combination thereof, with another compound, to form a polymer.

The method can include polymerizing the 2-hexene-1,6-dioic acid, the 3-hexene-1,6-dioic acid, the adipic acid, or a combination thereof, with a compound having the structure H₂N—(C₁-C₂₀)alkylene-NH₂, HO—(C₁-C₂₀)alkylene-NH₂, HO—(C₁-C₂₀)alkylene-OH, a salt thereof, or a combination thereof, wherein the (C₁-C₂₀)alkylene group is substituted or unsubstituted, to form a polymer.

The polymerizing can form a polymer including a repeating group having the structure:

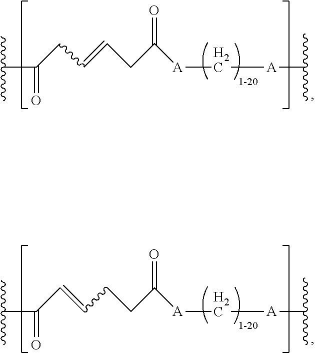

a salt thereof, or a combination thereof. At each occurrence -A- is independently chosen from —NH— and —O—.

The polymerizing can form a polymer including a repeating group having the structure:

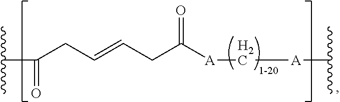

or a salt thereof. At each occurrence -A- is independently chosen from —NH— and —O—.

In various embodiments, the compound having the structure H₂N—(C₁-C₂₀)alkylene-NH₂ is hexamethylenediamine, and the polymerizing forms a polymer including a repeating group having the structure:

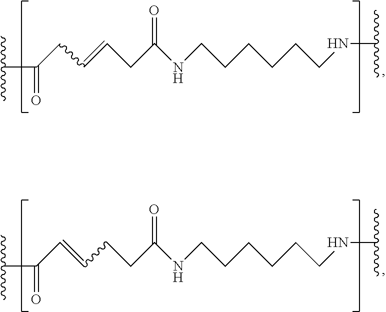

a salt thereof, or a combination thereof.

The method can include forming adipic acid via an embodiment of the electrocatalytic hydrogenation of muconic acid. The method can include polymerizing the adipic acid with another compound, to form a polymer. The method can include polymerizing the adipic acid with a compound having the structure H₂N—(C₁-C₂₀)alkylene-NH₂ or a salt thereof, wherein the (C₁-C₂₀)alkyl group is substituted or unsubstituted, to form a polymer. The compound having the structure H₂N—(C₁-C₂₀)alkylene-NH₂ can be hexamethylenediamine, wherein the polymer is nylon 6,6. The polymerizing can form a polymer including a repeating group having the structure:

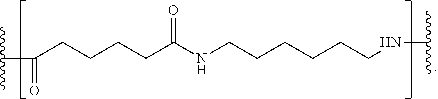

In various embodiments, the present invention provides a method of forming a polymer including polymerizing the 2-hexene-1,6-dioic acid, the 3-hexene-1,6-dioic acid, or a combination thereof, with a compound having the structure H₂N—(C₁-C₂₀)alkylene-NH₂ or a salt thereof, wherein the (C₁-C₂₀)alkyl group is substituted or unsubstituted, to form a polymer.

### EXAMPLES

Various aspects of the present invention can be better understood by reference to the following Examples which are offered by way of illustration. The present invention is not limited to the Examples given herein.

U.S. Pat. No. 10,633,750 is hereby incorporated by reference in its entirety.

### Example 1. Investigation of Selectivity for Adipic Acid from cis,cis-Muconic Acid

Materials. cis,cis-Muconic acid (ccMA, 97%), adipic acid (AA, 99%), dimethylmalonic acid (DMA, TraceCERT® grade for qNMR), deuterium oxide (D₂O, 99.9 atom % D), potassium sulfate (K₂SO₄, 99%), were purchased from Millipore Sigma. trans-3-hexenedioic acid (t3HDA, 98%) was purchased from Tokyo Chemical Industries. Graphitic carbon felt (0.125 in. thick, 99%) was purchased from Fisher Scientific. The conductive carbon tape was purchased from Electron Microscopy Sciences. Palladium and platinum foils (0.001 in. thick, 99%) were purchased from Fisher Scientific. Pd/C (5 wt. %) and Pt/C (5 wt. %) powders with average metal particle size ˜3 nm were purchased from Millipore Sigma. Deionized (DI) water (18.2 MΩ cm, Barnstead™ E-Pure™) was used for all experiments in this work.

### Experimental Details.

Model solutions having pH 1 were prepared by first dissolving 50 mg of ccMA in deionized (DI) water; upon dissolution, 18.2 M sulfuric acid (H₂SO₄) was added to obtain an electrolyte concentration of 0.1 M. We remained below the solubility limit of 1 g/L at pH 1. We found that accelerating the dissolution process with the help of ultrasound mitigated isomerization to ctMA and maintaining the temperature at less than 30° C. limited the lactonization process. As such, we managed to consistently prepare stock solutions with <12-18% ctMA and muconolactone (Mlac). All Mlac was consumed when we performed ccMA ECH at higher catalyst loadings. t2HDA is not commercially available, and therefore, we synthesized it through base-catalyzed isomerization of t3HDA with purity up to 70-80% t2HDA along with t3HDA.

Model solution having pH 7 was prepared using a 0.5 M phosphate buffer. Sodium phosphate dibasic (Na₂HPO₄, 98%) and sodium phosphate monobasic monohydrate (NaH₂PO₄·H₂O, 98%) used to prepare pH 7 buffer solutions were purchased from Millipore Sigma. Model solutions were prepared by dissolving 0.1M K₂SO₄ supporting electrolyte followed by 500 mg of ccMA in the as prepared buffer solution and making up the volume to 100 ml.

All electroanalytical measurements and bulk electrolysis were performed using a BioLogic SP-150e potentiostat coupled with a VMP3 10A booster. The uncompensated solution resistance was measured by potentiostatic electrochemical impedance spectroscopy (PEIS) and an 85% iR compensation was applied by the electrochemical workstation to all measurements. Flow measurements were conducted in a single-compartment micro-flow cell reactor purchased from Electrocell (Amherst, NY). The reactant solution was looped through the reactor at different flow rates using a Fisherbrand™ GP1000 pump. Ag/AgCl was attached with a PTFE separator as a reference electrode, and a platinized titanium plate (purchased from Electrocell, Amherst, NY) was used as a counter electrode. The working electrode consisted of either Pt or Pd foils (2×2 cm), or 1 mg of commercial 5 wt. % Pt/C or Pd/C ink drop-casted on a glassy carbon electrode. A graphite plate electrode was used to mount the foils and the supported metal catalysts in the flow reactor assembly which also acted as a charge collector. The electrode working area was confined to a maximum of 10 cm² using EPDM rubber gaskets, providing additional sealing. The aliquots were dried in air overnight and then redissolved in an internal standard solution containing DMA dissolved in deuterium oxide D₂O. The samples were then analyzed by ¹H-NMR using a Bruker 600 MHz spectrometer to identify the product conversion. All calculations were performed on a weight fraction basis.

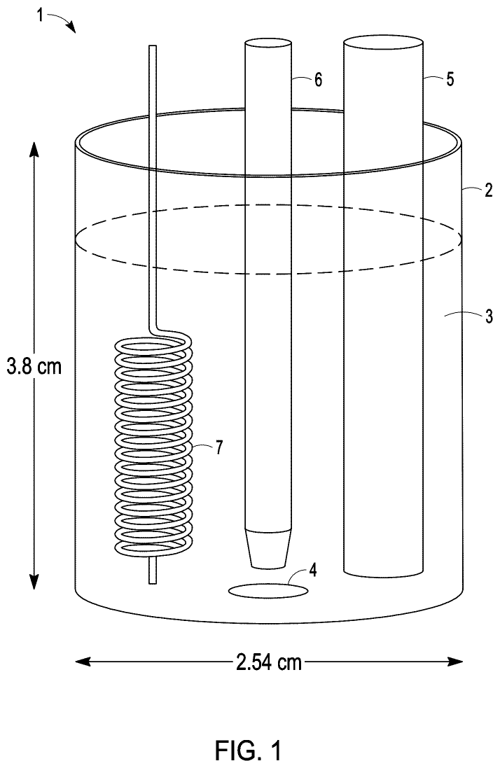

FIG. 1 illustrates the three-electrode electrochemical cell (1) used to carry out electrocatalytic hydrogenation studies. The container (2) was about 2.54 cm in diameter and about 3.8 cm high. The electrolyte level (3) shown is approximate. Current was passed through an aqueous reaction medium (3) including 1% formic acid in water (electrolyte) and varying concentrations of muconic acid. An Ag/AgCl reference electrode in 4 M KCl (E⁰=+0.197 V vs. NHE) (6) and platinum counter electrode (7) were purchased from Pine Research Instrumentation. Controlled voltage was applied using a Biologic VSP-300 potentiostat from BioLogic (not shown). The electrolyte was agitated via magnetic stirring using stir bar (4).

### Computational Details.

Plane-wave DFT calculations were performed using the Vienna Ab-initio Simulation Package (VASP). Electron-ion interactions were quantified by projector augmented wave (PAW) potentials. Exchange correlations were calculated using Perdew-Burke-Ernzerhof (PBE) functionals. The zero-damped DFT-D3 method was implemented to apply dispersion corrections. Dipole corrections were applied in the z-direction normal to the surface. The kinetic energy cutoff was set to 400 eV, with electronic convergence calculated to 10⁻⁴ eV.

Calculations on (111) surfaces were performed using a 5×5×4 periodic unit cell; those on (533) surfaces were performed with a 4×5×4 periodic unit cell. Metal atoms in the bottom two layers of all the slabs were fixed at their respective bulk positions; all other atoms, including adsorbates, were fully relaxed. A 4×4×1 Monkhorst-Pack k-point grid was used for these surface calculations; the grid was gamma-centered on (111) surfaces. At least 14 Å of vacuum spacing was used between periodic images. DFT-calculated lattice constants of bulk Pd and Pt were used to construct all slab models (experimental values are provided in parentheses, all values in Å): Pd 3.89 (3.89), Pt 3.92 (3.92). For geometric optimization, ionic forces on each atom were converged to 0.02 eV/Å. Transition states and activation energies for surface-mediated elementary steps were evaluated using the climbing image nudged elastic band method; seven interpolated images and a force convergence criterion of 0.05 eV/Å were used to calculate activation energies.

The Gaussian 09 simulation package was used to determine solution phase Gibbs free energies. The QB3 variant of Complete Basis Set (CBS) extrapolation method was used; optimizations were performed with the “verytight” convergence criteria. The SMD variant of the Polarizable Continuum Model (PCM) with integral equation formalism variant was used to model the presence of water (solvent).

Gibbs free energies of all species were referenced to the gas phase free energies of ccMA and H₂, and the energy of clean slabs:

$${G}_{{A}^{*}} = ( {E}_{{A}^{*}} + {ZPE}_{{A}^{*}} - {TS}_{A} * ) - {E}_{surf} - ( {E}_{MA , g} + {ZPE}_{MA , g} - {TS}_{MA , g} ) - \frac{m}{2} ( {E}_{{H}_{2} , g} + {ZPE}_{{H}_{2} , g} - {TS}_{{H}_{2} , g} ) \qquad ( 1 )$$

Here, Eᵢ are DFT-calculated total energies, ZPEᵢ are calculated zero-point energies, and Sᵢ are calculated entropies. Systems denoted with A* contain species A adsorbed on the surface; systems with subscript “g” refer to respective gas-phase quantities (all the required quantities are provided in Table S1-S6). E_{surf} is the total energy of the clean slab. The harmonic oscillator approximation was used to calculate ZPE and S. The temperature (T) is 298 K, in accordance with experimental conditions. The constant m corresponds to the stoichiometric coefficient for H₂.

Assuming equilibrium between H_{2(g)} and proton/electron pairs, the computational hydrogen electrode model was used to apply a linear correction to the free energies of faradaic elementary steps:

$${A}^{*} + ( {H}^{+} + {e}^{-} ) \to {B}^{*} \qquad ( 2 )$$

$$Δ G ( {U}_{RHE} ) = {G}_{{B}^{*}} - {G}_{{A}^{*}} + \vert e \vert {U}_{RHE} \qquad ( 3 )$$

U_{RHE} is the external cell potential with the reference to the reversible hydrogen electrode (RHE) and e is the electron charge. An additional linear correction term was applied to the DFT-calculated activation free energies (Gₐ(U_{0,RHE})) to account for the applied electrode potential:

$${G}_{a} ( {U}_{RHE} ) = {G}_{a} ( {U}_{0 , RHE} ) + {β}^{*} ( {U}_{RHE} - {U}_{0 , RHE} ) \qquad ( 4 )$$

Here, U_{0,RHE} is the onset potential (with the reference to the RHE) for coadsorption of H* (relative to H_{2(g)}) in the presence of the reactant molecule for the respective hydrogenation step on a modelled catalyst surface. We assume the value of the symmetry factor (β) to be 0.5, noting potential limitations of this assumption.

Cell potentials experimentally referenced to the Ag/AgCl electrode were converted to a reference vs. the RHE using the following expression: U_{RHE}=U_{Ag/AgCl}+0.197+0.059*pH. All DFT calculations for H⁺/e⁻ transfer steps were accordingly presented at 298 K and U_{RHE}=−0.14 V to match the cell potential of −0.40 V vs. Ag/AgCl for the bulk electrolysis experiments at pH 1. Due to differences in DFT methods used for calculating solution-phase reaction energetics (hybrid functionals in Gaussian 09) and those at metal surfaces (PBE functionals with plane-wave basis), the thermodynamic cycle must be closed via Hess's law for consistency. We calculated the adsorption energy of ccMA* relative to a gas-phase ccMA reference; these and all subsequent surface-mediated steps were calculated using VASP relative to the common references. We also calculated the energetics of species from ccMA to AA using Gaussian 09 as described above. To maintain consistency of the thermodynamic cycle, we then applied Hess's law to implicitly determine the desorption energies of t2HDA, t3HDA, and AA such that the path to forming each of these species (whether via the surface or solution) has the same net energy change from the ccMA starting point to the given end point. We recognize that this will overestimate the binding strength of ccMA, t2HDA, t3HDA, and AA, as a gas-phase reference for ccMA is more unstable than the “true” reference state, though calculating the appropriate reference energy of ccMA is nontrivial due in part to the low solubility of ccMA in solution. The conclusions of this work are unaffected by the absolute magnitudes of adsorption/desorption energies.

### Results and Discussion.

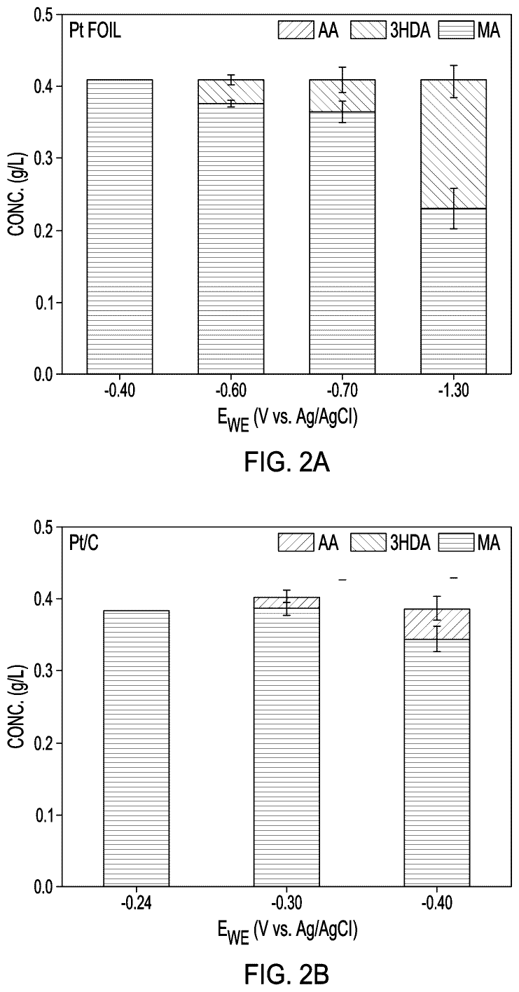

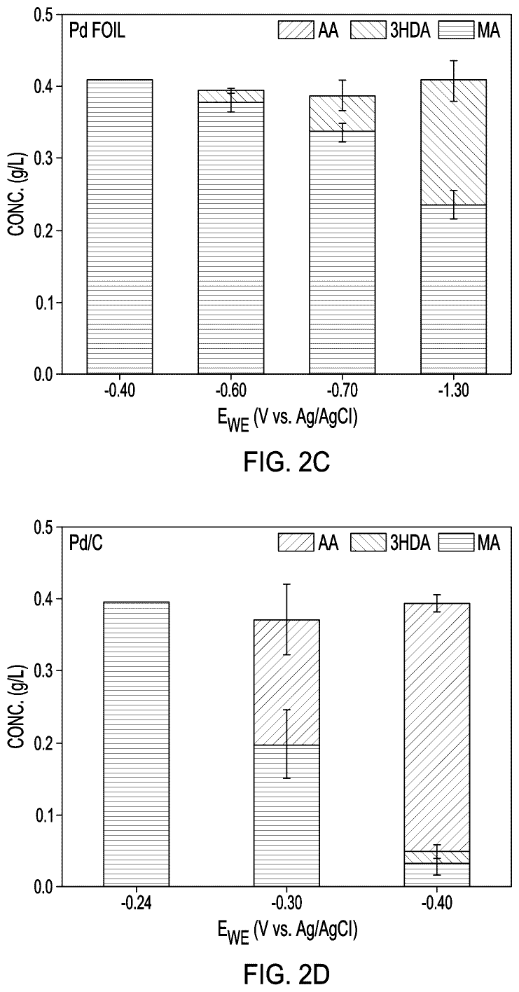

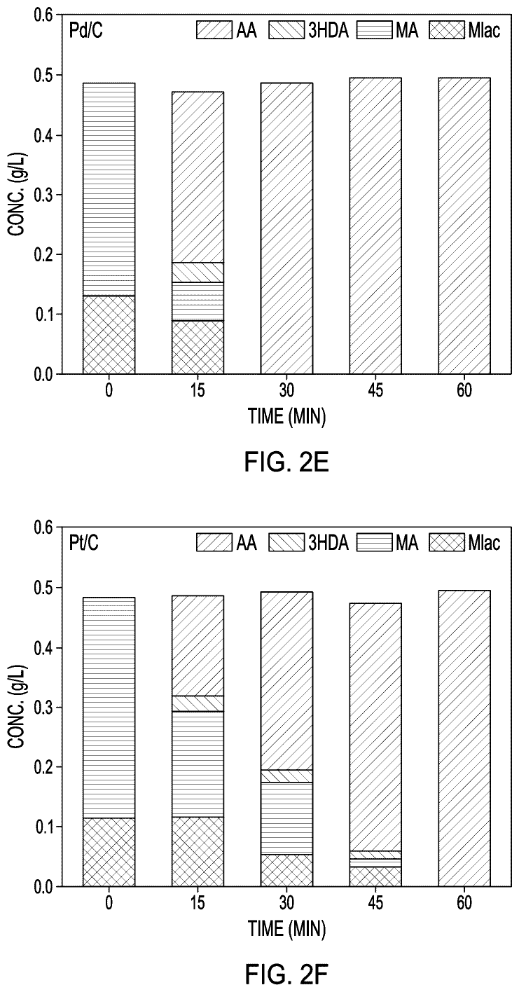

Given the substantial conversion and turnover frequencies (TOFs) of MA to AA achieved via thermocatalytic hydrogenation with Pd- and Pt-based catalysts, we initiated our study by screening different geometries (foils vs nanoparticle) of these catalysts for ccMA ECH. We performed chronoamperometry experiments at various cathodic potentials. FIGS. 2A-2D illustrate concentration (g/L) of reactants and products in solution after 1 hour of chronoamperometry (CA) experiments performed at varying working potentials (E_{we}) on (2A) Pt foil, (2B) Pt/C, (2C) Pd foil, and (2D) Pd/C. The error bars represent the standard error from triplicates. In addition to these products, we observed a small concentration (0.1 g/L) of muconolactone (not shown here for simplicity) that remained constant throughout the course of the reaction on all materials and at all potentials. We used a flow reactor system under acidic conditions expecting faster rates in the presence of a readily available proton source (H₃O⁺). During the screening process, we found surprisingly high activity on Pd nanoparticles with a TOF_{MA}: 1.1 s⁻¹ and ccMA conversion rate of 91% after 1 h. The selectivity was greater than 95%, and the faradaic efficiency (FE) was 18% at −0.4V_{Ag/AgCl}.

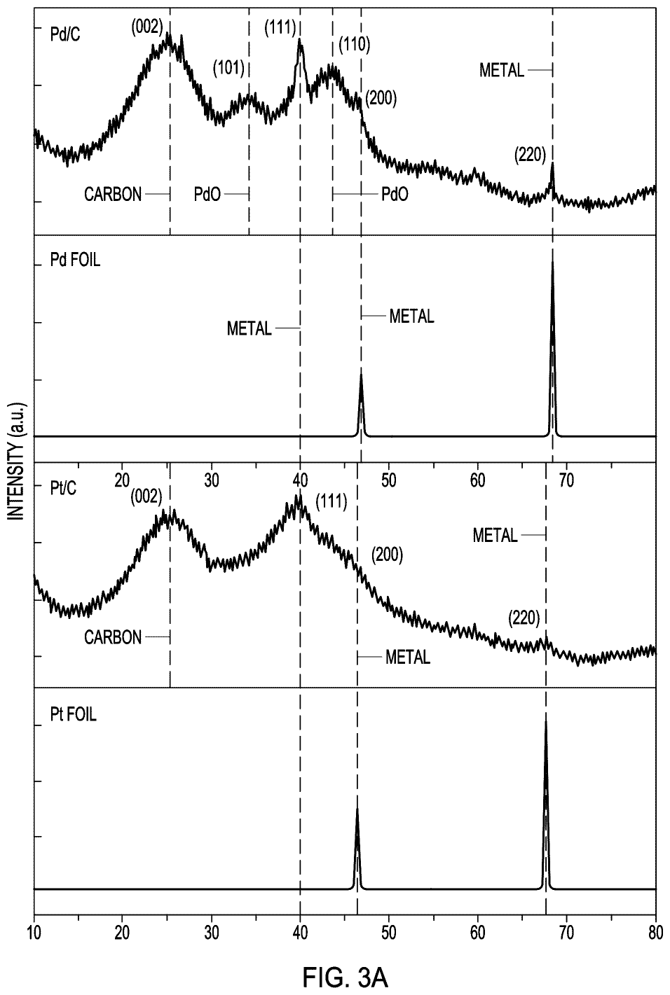

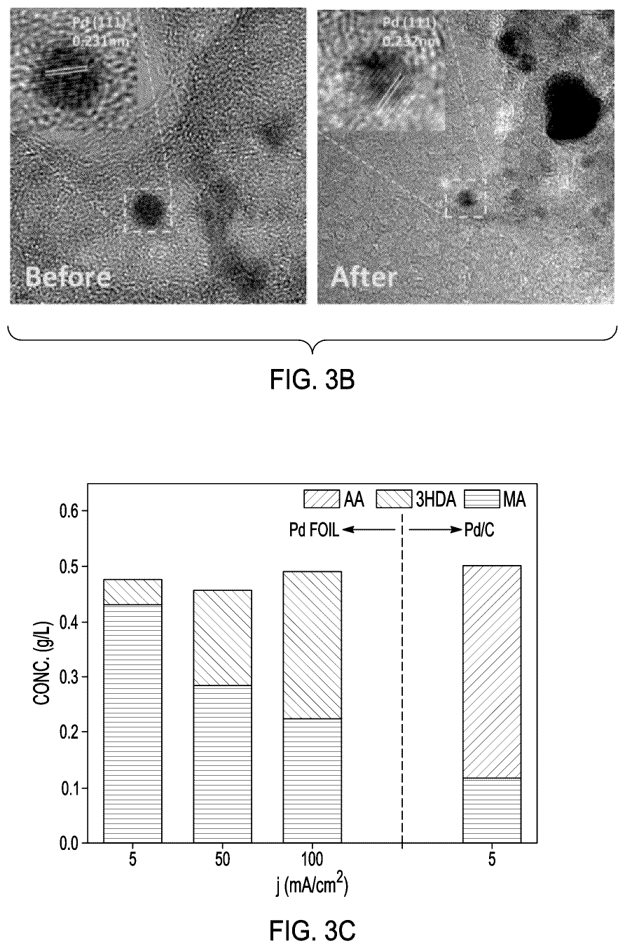

Based on the constant voltage bulk electrolysis experiments for higher catalyst loading (10 mg), we observed 100% conversion and selectivity to AA on Pd/C and Pt/C. FIGS. 2E-2F illustrate concentration of reactants and products in solution during chronoamperometry experiments performed for 1 h at −0.4 V_{Ag/AgCl} on 10 mg of (1E) Pd/C, and (1F) Pt/C. Notation: muconic acid (MA), trans-3-hexenedioic acid (3HDA), muconolactone (Mlac), and adipic acid (AA). These observations, combined with DFT calculations in the following section, identify t3HDA and t2HDA as reaction intermediates to form AA. Such high yield of AA on Pd/C suggests that the final process design for synthesizing bio-based AA might not require complicated downstream separation processes. However, Pt nanoparticles were less active for AA and favored HER over ECH. In contrast to the performance on nanoparticles, Pd and Pt foils did not produce AA, yielding t3HDA as the sole product with poor FE (<5%). We performed constant-current experiments (FIG. 3C) to verify that the observed product distribution is not an artifact of differences in mass-transfer kinetics across different materials. Even after increasing the current density up to 100 mA/cm², we still observed t3HDA as the only product on either of the foils.

To understand the crystallographic nature of foils and nanoparticles, we performed X-ray diffraction measurements (FIG. 3A). In our X-ray diffractograms, we observed Pd/C and Pt/C primarily exhibiting (111) facets which are characteristic of the fcc crystal. The orientation was confirmed with the d-spacing from TEM images (FIG. 3B) of Pd/C, inferring we indeed have (111) terraces which are stable after multiple runs. The foils exhibit an abundance of (110) and (110) step sites, consistent with the literature.

We performed DFT calculations to elucidate the difference in performance of ccMA ECH on foils and nanoparticles. Model (111) terraces and (533) step surfaces were investigated to understand reaction energetics. Energetics were calculated at −0.14 V vs. the reversible hydrogen electrode (V_{RHE}), equivalent to −0.40 V_{Ag/AgCl} at the relevant experimental conditions. Adsorption of ccMA on Pd(111) and Pt(111) surfaces was thermodynamically favorable, with adsorption free energies of −1.91 eV and −2.01 eV, respectively. However, the activation free energies for hydrogenation to cMAH-2ad* were relatively high (0.82 eV for Pd and 0.40 eV for Pt), making a non-catalytic outer-sphere mechanism in solution more favorable (ΔG=0.08 eV). While cMAH-2ad can adsorb on these surfaces, its hydrogenation to t2HDA or t3HDA is more favorable in solution due to high surface activation energies. Surface-mediated formation of t2HDA or t3HDA is unlikely, with t2HDA more readily undergoing ECH on the surface due to lower activation energies. For t3HDA, a surface-catalyzed pathway is suggested, potentially involving isomerization to t2HDA* (wherein “*” denotes absorbed species) for further ECH. Overall, Pt(111) binds species more strongly than Pd(111), explaining the relatively poor experimental ECH activity to AA on Pt surfaces.

Similarly, we calculated reaction energetics on Pd(533) and Pt(533) surfaces to understand the impact of undercoordinated atoms at step edges on ccMA ECH. Similar to the (111) surfaces, high activation energies suggest that ccMA ECH to t2HDA/t3HDA occurs via an outer-sphere mechanism. Although t2HDA and t3HDA adsorption is more favorable on these stepped surfaces, the subsequent surface-mediated activation energies are substantially higher, consistent with the principle that stronger-binding surfaces have high barriers for bond-making steps. Thus, stepped surfaces are relatively inactive for ccMA ECH due to their strong-binding nature. Hence, experimentally, we do not observe any AA on foils which have predominantly step sites.

To drive sustainable chemical transformations, atomic-scale innovation is essential for designing systems with optimal activity and selectivity. This study is the first to report significant AA production from ccMA ECH using nanostructured Pd or Pt catalyst, with Pd/C showing the highest activity. Computational and experimental analyses reveal that the initial reduction of ccMA to t2HDA/t3HDA likely occurs through an outer-sphere mechanism, while the further reduction to AA happens via a surface-mediated pathway. Operating under acidic conditions provides us with a readily available proton source in the form of H₃O⁺, thus achieving high rates. Abundance of protons in the electrolyte also enhances simultaneous HER hampering the faradaic efficiency. Besides, the reaction is limited due to poor solubility of ccMA under acidic conditions, which increases exponentially towards neutral pH. Under neutral pH conditions, we lose the proton source observing a decline in HER rates. Combined with the deprotonation of ccMA, we observe an increase in the overpotential required to maintain desirable rates. This can be tackled by tuning other parameters such as supporting electrolyte, altering the carbon support or by critical designing of the active phase. Overall, neutral pH conditions provide us with room to modulate reaction parameters for achieving high rates required to compete with thermochemical pathways.

AA was observed on nanostructured Pd and Pt catalysts under acidic conditions.

### Example 2. Neutral Conditions

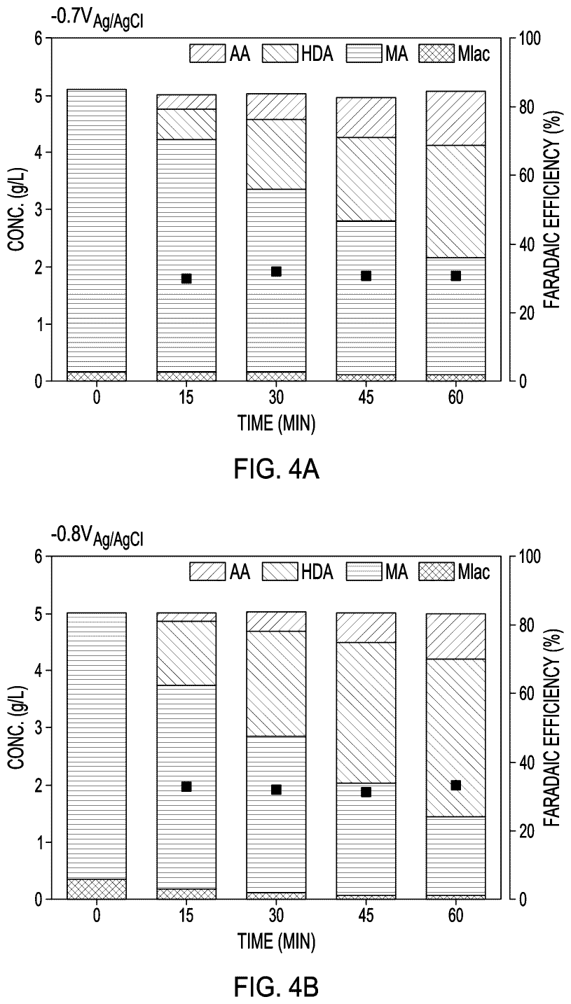

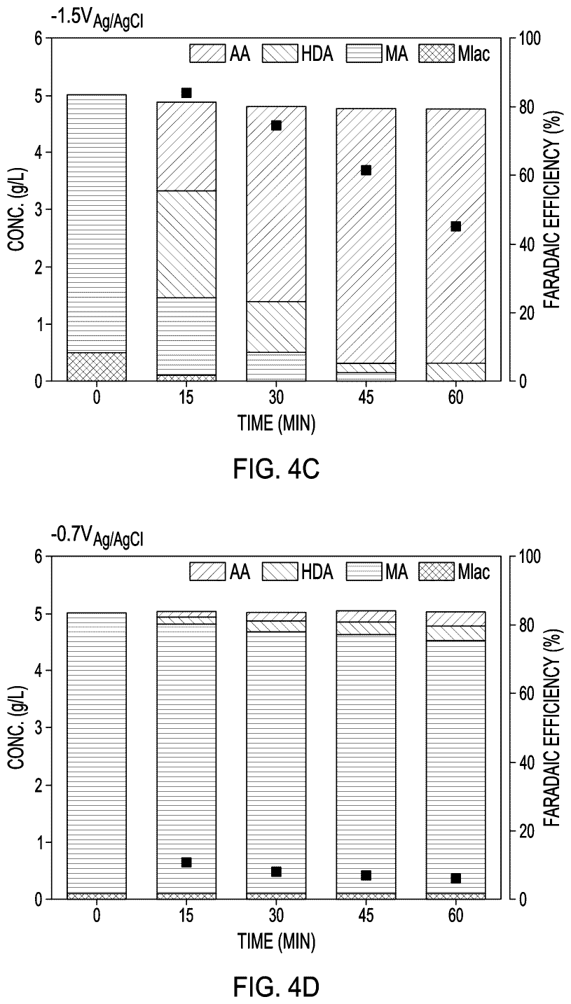

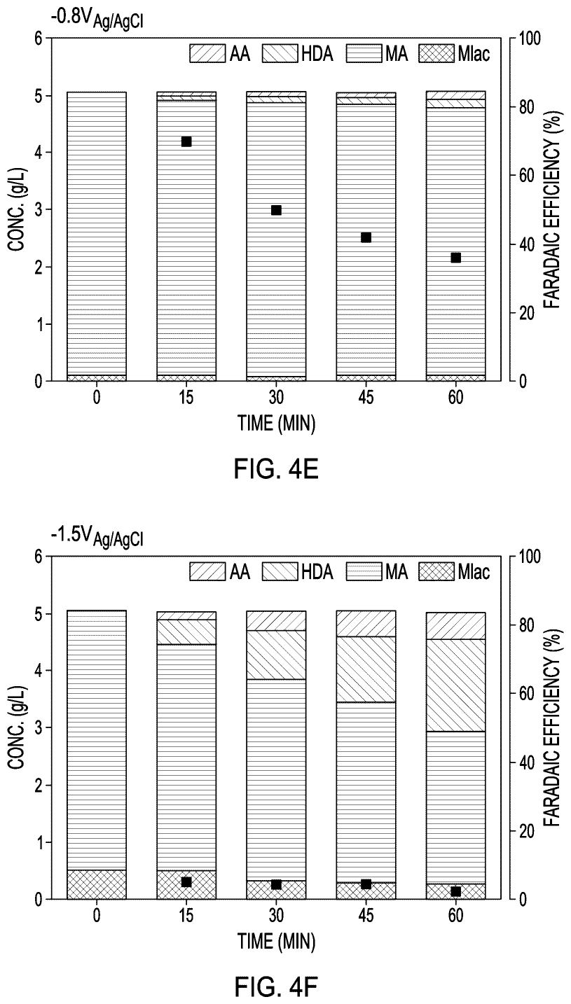

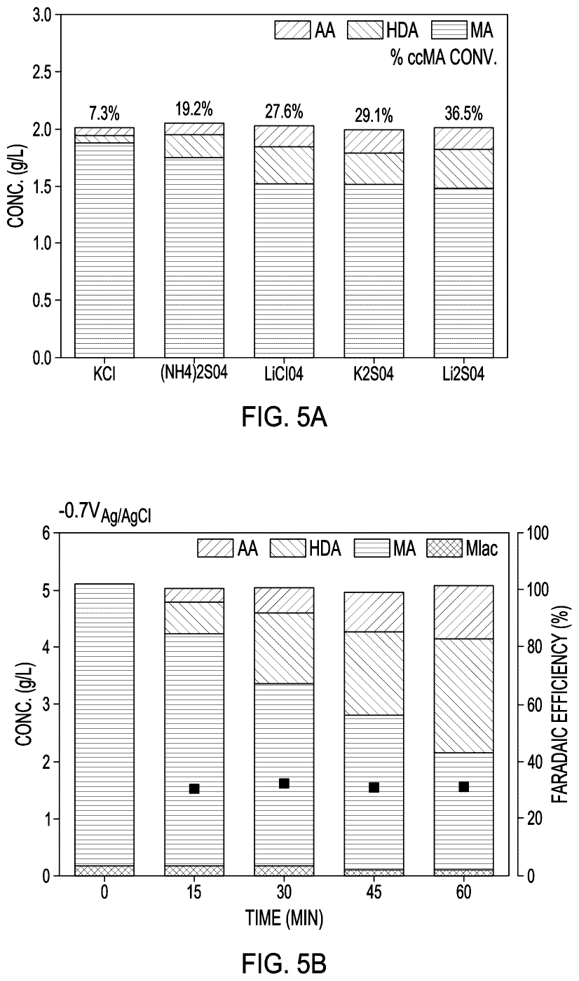

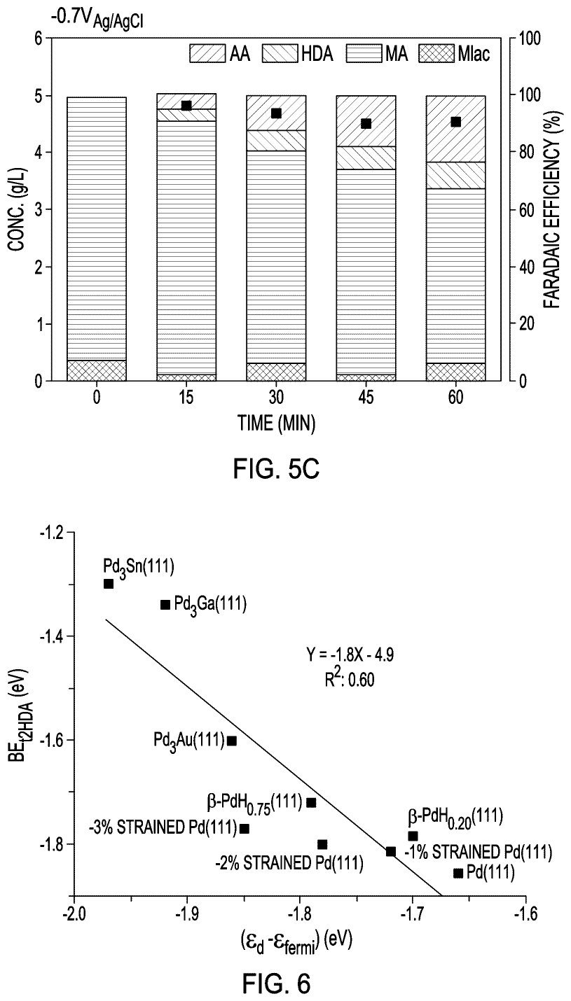

As a continuation of Example 1, to replicate the results under neutral conditions, chronoamperometry experiments were conducted using Pd/C and Pt/C catalysts. Sulfuric acid electrolyte was now replaced with 0.5 M phosphate buffer to maintain ccMA in its deprotonated form, while supporting electrolyte was added to boost the conductivity. Chronoamperometry experiments were performed using the microflow reactor using 10 mg of catalysts deposited on carbon felt. FIGS. 4A-F illustrate concentration of reactants and products in solution as a function of time during chronoamperometry experiments performed at varying working potentials (E_{we}) on 10 mg of Pd/C (4A, 4B, and 4C) and on 10 mg of Pt/C (4D, 4E, 4F). Notation: MA: muconic acid, HDA: trans-3-hexenedioic acid & trans-2-hexenedioic acid, AA: adipic acid, Mlac: muconolactone. As seen in FIGS. 4A-C, Pd/C performed exceptionally with the TOF increasing with increasing cathodic potential. We observed TOF as high as 3.9 s⁴ with up to 80% FE at −1.5V_{Ag/AgCl} which is a significant improvement as compared to Pd/C in acidic conditions. Allowing the reaction for extended periods resulted in complete hydrogenation to AA. Unlike Pd/C, Pt/C majorly performed HER and hence the FE remained poor (<11%) at all potentials. All the experiments were performed with 0.1M K₂SO₄ as a supporting electrolyte. This performance can be further improved by changing the electrolyte. Preliminary measurements were conducted to observe the effect of different supporting electrolytes. FIG. 5A illustrates concentration of reactants and products in solution after 1 h of chronoamperometry experiments performed at −0.7VAg/AgCl with 0.1 M of various supporting electrolytes, demonstrating a significant improvement in conversion and ECH rates when switching from KCl to Li₂SO₄. Supporting electrolytes are known to influence the electrical double layer properties. Thus, further investigation is needed to optimize the electrolyte composition for best results.

All the catalysts tested in the microflow reactor are deposited on a 3 mm thickness carbon felt as a support. At higher potentials, the carbon felt (CF) is also active for ECH due to its excellent conductivity. Due to which the CF actively participates in hydrogenating ccMA to selectively produce t3HDA. Further hydrogenation to AA is not observed on the CF, supporting our hypothesis that further hydrogenation is a surface mediated reaction needing specific active sites. In order to decouple the role of CF, we replaced it with a conductive carbon tape (thickness <1 mm) to mobilize our catalyst in the flow system. Chronoamperometry experiments were conducted using 10 mg of Pd/C deposited on the carbon tape at −0.7V_{Ag/AgCl}. FIGS. 5B-C illustrate concentration of reactants and products in solution during chronoamperometry experiments performed for 1 h using (5B) 10 mg of Pd/C deposited on carbon felt, and (5C) 10 mg of Pd/C deposited on carbon tape (notation: MA: muconic acid, HDA: trans-3-hexenedioic acid & trans-2-hexenedioic acid, AA: adipic acid, Mlac: muconolactone), demonstrating a significant increase in the FE up to 96% as compared to 28% with the CF. The improved FE comes at the expense of a drop in TOF by nearly 50% (0.6 s⁻¹ on C-tape), but the reaction is much more selective towards AA (78%). Optimizing supported metal catalyst performances often involves manipulating the composition, geometry, and crystallographic features of active sites; however, these results signify that the importance of the support characteristics should not be overlooked.

### Example 3. Theory-Guided Active Phase Design

As a continuation of Examples 1 and 2, we concluded that optimizing the structure of exposed facets and metal identity can help tune the selectivity of ccMA ECH to AA vs. HDA. The binding strength of t2HDA on Pd(111) (−0.63 eV) and Pt(111) (−1.11 eV), and t2HDA ECH barriers on the respective surfaces (Pd(111): 0.39 eV, Pt(111), 0.48 eV) suggest that both Pd and Pt lie on the strong-binding leg of the ECH activity volcano. This is confirmed by the weaker binding of t2HDA (−0.53 eV) and lower ECH barrier (0.29 eV) on 0-PdH_0.75(111). Therefore, further weakening the binding strength of t2HDA could be beneficial for ECH of t2HDA to AA. The adsorbate binding energy can be described as a function of the metal d-band center, within the same series of materials. FIG. 6 illustrates DFT-calculated binding energy of trans-2-hexenedioic acid (BE_{t2HDA}, eV) as a function of the d-band center of Pd (ε_{d}−ε_{fermi}, eV), revealing a strong correlation between the t2HDA binding and the d-band center of Pd among several Pd-based candidate surfaces. This comparison suggests that alloying Pd(111) with p-block elements like Ga and Sn could be a potential strategy to reduce the binding strength of t2HDA and enhance selectivity to AA.

### Example 4. Investigation of Catalyst Poisoning and Rejuvenation of Poisoned Catalyst

Chemicals. Concentrated sulfuric acid (H₂SO₄, Certified ACS Plus, Fisher Chemical™), cis-cis-muconic acid (C₆H₆O₄, >97.0% (HPLC), Sigma-Aldrich), chloroplatinic acid hexahydrate (H₂PtCl₆·6H₂O, ACS reagent, ≥37.50% Pt basis, Sigma-Aldrich), dimethylmalonic acid (C₅H₈O₄, 98%, Sigma-Aldrich), and deuterium oxide (D₂O, 99.9%, Cambridge Isotope Laboratories) were used as received. All electrolyte solutions were prepared in deionized (DI) water (18.2 MΩ cm resistivity at 20° C., Barnstead™ E-Pure™).

Biogenic Impurities. L-cysteine (C₃H₇NO₂S, from non-animal source, BioReagent, suitable for cell culture, ≥98%), L-methionine (C₅H₁₁NO₂S, reagent grade, ≥98% (HPLC)), proteose peptone (Enzymatic hydrolysate), and L-tryptophan (C₁₁H₁₂N₂O, reagent grade, ≥98%), L-alanine (C₃H₇NO₂, BioUltra, ≥99.5% (NT)), L-glutamic acid (C₅H₉NO₄, ≥99% (HPLC), suitable for microbiological culture, ReagentPlus®), glycine (C₂H₅NO₂, ACS reagent grade, ≥98.5%), 1-propanethiol (C₃H₈S, 99%), and glutathione (C₁₀H₁₇N₃O₆S, Pharmaceutical Secondary Standard; Certified Reference Material) were purchased from Sigma Aldrich. 1-cysteic acid (C₃H₇NO₅S, 99%, Thermo Scientific) was purchased from Fisher Scientific.

Synthetic Fermentation Broth. Citric acid monohydrate (C₆H₈O₇·H₂O, Granular/Certified ACS), magnesium sulfate anhydrous (MgSO₄, Powder/Certified), calcium chloride anhydrous (CaCl₂, Pellets, 4-20 mesh, for Desiccators), ferric chloride hexahydrate (FeCl₃·6H₂O, Lumps/Certified ACS), manganese chloride tetrahydrate (MnCl₂·4H₂O, Crystalline/Certified ACS), boric acid (H₃BO₃, Powder/Certified ACS), and glucose (C₆H1₂O₆) were purchased from Fisher Chemical. Ferric citrate (C₆H₅FeO₇, BioReagent, suitable for cell culture), 4-aminobenzoic acid (C₇H₇NO₂, 99%, for peptide synthesis, ReagentPlus®), 4-hydroxybenzoic acid (C₇H₆O₃, ReagentPlus®, 99%), copper(II) chloride (CuCl₂, powder, 99%), sodium molybdate dihydrate (Na₂MoO₄·2H₂O, ACS reagent, ≥99%), and zinc chloride (ZnCl₂, reagent grade, ≥98%) were purchased from Sigma-Aldrich. Cobalt (II) chloride hexahydrate (CoCl₂·6H₂O, purum, crystallized, ≥98.0% (KT)) was purchased from Fluka Analytical.

Electrochemical experiments. All electrochemical experiments were conducted using a 150 mL electrochemical cell (Pine Research Instrumentation) configured as a three-electrode system, consisting of a platinum (Pt) coil counter electrode (CE) (99.99% pure, Pine Research Instrumentation) and an Ag/AgCl reference electrode (RE) (saturated KCl, Pine Research Instrumentation). Electrocatalytic reactions were characterized using cyclic voltammetry (CV) and chronoamperometry (CA) on an SP-150e potentiostat (BioLogic). Electrolyte solutions were degassed with argon for at least 15 minutes prior to each experiment, and argon flow was maintained throughout the experiments. All potential values reported are referenced against the Ag/AgCl (saturated KCl) reference electrode.

### Catalyst Poisoning Induced by Cysteine and Regeneration Under Electrochemical Conditions.

Electrode preparation. Platinum (Pt) rotating disk electrodes (RDEs) (5.0 mm OD, 0.196 cm²geo; Pine Research Instrumentation) were used as working electrodes (WE). The RDE was gently inserted into an RDE holder (E4TQ Series PTFE ChangeDisk RDE Tip; Pine Research Instrumentation), and the electrode surface was manually polished using alumina slurries of varying particle sizes (5 μm, 0.3 μm, and 0.05 μm; Allied High Tech Products) and a 0.05 μm water-based polycrystalline diamond slurry (Allied High Tech Products). The polishing procedure began with 5 μm alumina on a Nylon pad (Buehler) using a figure-8 motion for 5-6 minutes, followed by sequential polishing with 0.3 μm and 0.05 μm alumina suspensions (DeAgglomerated), and then with 0.05 μm diamond suspension on a MicroCloth pad (Buehler). After each polishing step, the RDE was thoroughly rinsed sequentially with deionized (DI) water, acetone, and deionized (DI) water. Following polishing, the RDE holder was connected to a modulated speed rotator (Pine Research Instrumentation), which was operated at a fixed rotation rate of 1600 rpm for all experiments.

Electrochemical characterization. Catalyst activity for the hydrogen evolution reaction (HER) in the absence and presence of biogenic impurities, as well as the subsequent electrochemical regeneration of the poisoned catalyst, was evaluated using cyclic voltammetry (CV). A 0.1 M H₂SO₄ solution was prepared by diluting concentrated H₂SO₄ in deionized (DI) water. Initially, 100 CV cycles were performed using the pristine catalyst in 0.1 M H₂SO₄ to establish a benchmark for maximum achievable catalytic activity. Steady-state CVs were obtained by cycling the electrode 100 times for each condition. Afterward, 1000 ppm impurity was introduced into the same solution, and CV cycling was restarted within the same potential window. Once stable CVs were obtained after 100 cycles in the impurity-containing electrolyte, the solution was replaced with fresh 0.1 M H₂SO₄, and another set of 100 CV cycles was performed to evaluate electrochemical regeneration. This regeneration step is referred to as the “first regeneration” throughout the study.

To further recover catalytic activity beyond the first regeneration, the partially regenerated catalyst was subjected to reductive stripping via chronoamperometry (CA) at incrementally negative potentials. Specifically, CA steps were applied at 0.1 V intervals, starting from −0.2 V and progressing in negative steps down to a maximum potential value to match activity like the pristine solution. After each CA step, a set of 100 CV cycles was performed to assess the extent of activity recovery. This predictive stripping protocol was continued until the recovered HER activity, as determined from the H_{UPD} region, matched that of the pristine catalyst.

Experimental parameters. For Pt, all CVs were performed from −0.2 V to 1.2 V at a scan rate of 500 mV/s.

XPS. Electrode poisoning was characterized using a Kratos Amicus XPS system equipped with a Mg Kα X-ray source, operated at a pass energy of 150 eV and an X-ray power of 240 W (12 kV×20 mA). Spectra were acquired with a step size of 0.1 eV and a dwell time of 0.5 s.

Electrocatalytic Hydrogenation of cis,cis-Muconic Acid to Adipic Acid on Pristine, Poisoned, and Regenerated Surfaces.

Electrodeposition of Pt on Pt Foil. Pt foil (2.5×2.5 cm, 0.025 mm thick, 99.9% metals basis; Thermo Scientific Chemicals) was cleaned sequentially with deionized (DI) water, acetone and deionized (DI) water, followed by flame-annealing for approximately 60 seconds and cooling in air. All electrochemical experiments were conducted as described in Section 2.2. The Pt foil was mounted in an electrode holder, and the solution was stirred at 350 rpm throughout the experiment. Using a 0.1 M H₂SO₄ solution, the Pt foil was first electropolished by cycling the potential 100 times at 500 mV/s between −0.500 V and 1.700 V. Following electropolishing, 50 CV cycles were performed within the typical Pt potential window (−0.2 V to 1.2 V) at 500 mV/s to characterize the clean electrode surface.

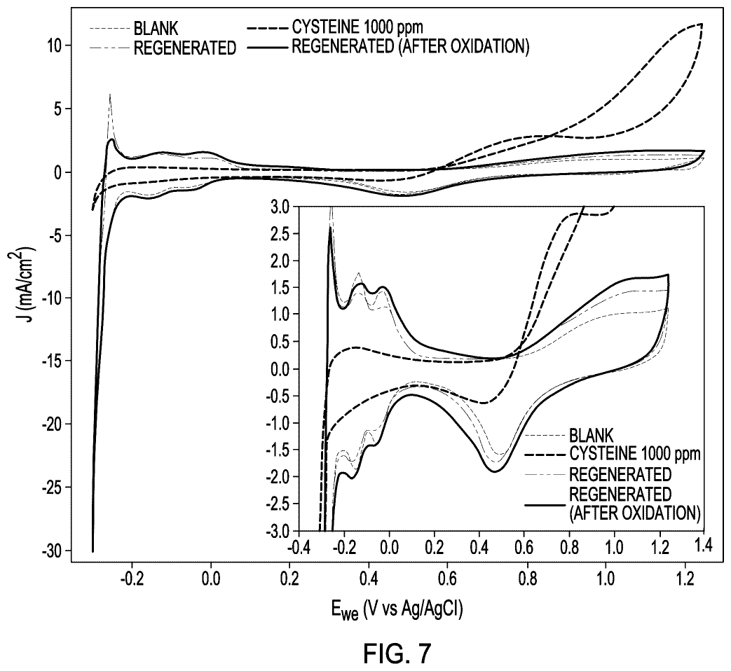

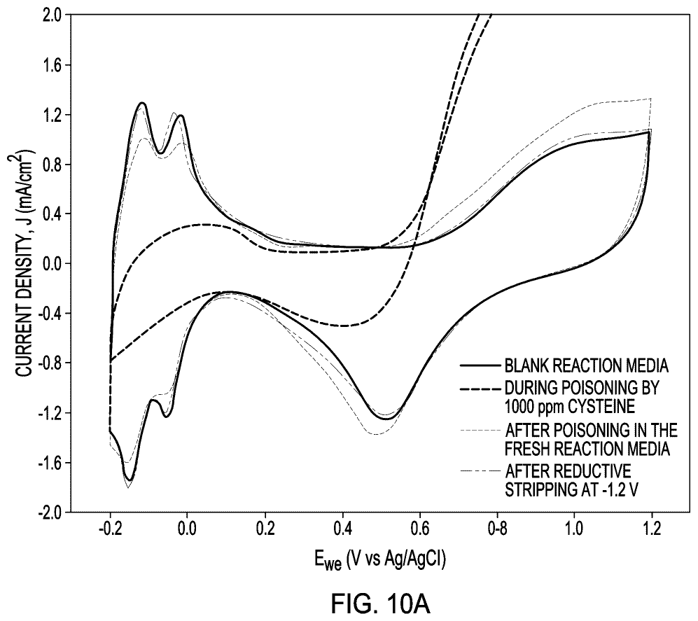

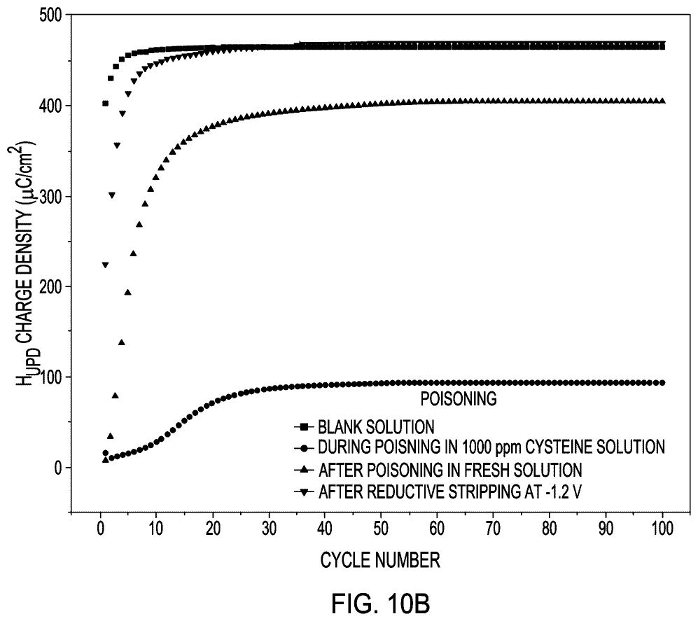

Electrodeposition of Pt onto the Pt foil was carried out using a cyclic voltammetry (CV) method. The deposition was performed in an electrolyte solution containing 5 mM H₂PtCl₆·6H₂O as the precursor and 0.5 M Na₂SO₄ as the supporting electrolyte. A total of 50 CV cycles were applied from −0.500 V to 1.700 V at a scan rate of 100 mV/s. The deposition area was confined to a 1.6×2.5 cm region of the Pt foil, with both sides of the foil exposed to the electrolyte. Successful electrodeposition was confirmed by subsequent CV characterization in 0.1 M H₂SO₄, scanned from −0.231 V to 1.2 V at 500 mV/s (FIG. 7) and −0.2 V to 1.2 V at 500 mV/s (FIG. 10A). Hereafter, the electrodeposited Pt foil is referred to as “Pt-dep-Pt-foil”.

XRD. A Siemens D 500 X-ray diffractometer equipped with a Cu Kα radiation source (λ=1.5432 Å) and a graphite monochromator on the diffracted beam was used to characterize the Pt-dep-Pt-foil for (111) facet orientation. The instrument was operated at 45 kV and 30 mA. X-ray diffraction (XRD) patterns were recorded over the 2θ range of 10° to 80°, with a step size of 0.02° and a dwell time of 2 seconds per step.

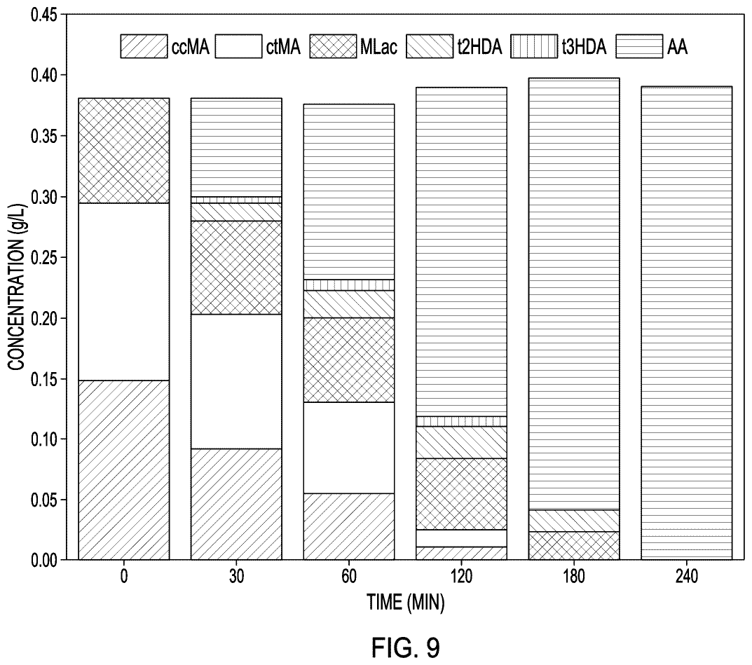

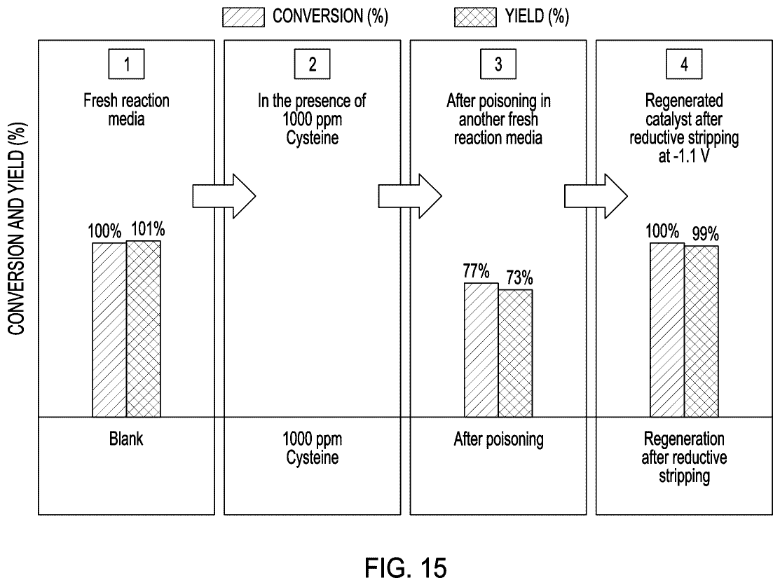

Electrocatalytic hydrogenation of ccMA to AA. The ECH of ccMA to AA was carried out using a three-electrode divided electrochemical setup with Pt-dep-Pt-foil as the working electrode (WE). The WE was mounted in an electrode holder, exposing a working area of 1.6 cm×2.5 cm to the electrolyte, with both sides of the Pt foil in contact with the solution. The experiment was performed in a divided cell, separated by a proton exchange membrane. The cathodic chamber contained 0.5 g/L ccMA dissolved in 0.1 M H₂SO₄, while the anodic chamber was filled with 0.1 M H₂SO₄. A low-profile Ag/AgCl reference electrode (Pine Research Instrumentation) was used, and a platinum foil (2.5×2.5 cm, 0.025 mm thick, 99.9% metals basis; Thermo Scientific Chemicals) served as the counter electrode. Argon was purged for at least 15 minutes prior to the experiment and maintained throughout to ensure an inert atmosphere. CA at −1.5 V was applied for 4 hours (FIG. 9) and CA at −0.7 V was applied for 6 hours (FIG. 15) to perform the ECH of ccMA.

To evaluate catalyst poisoning in the presence of impurity and its electrochemical regeneration, four distinct experiments were conducted: 1) A benchmark run using a pristine Pt-dep-Pt-foil in a 0.5 g/L ccMA solution (0.1 M H₂SO₄) in the cathodic chamber. 2) The same catalyst tested in a 0.5 g/L ccMA solution containing 1000 ppm cysteine. 3) The same (poisoned) catalyst re-tested in fresh 0.5 g/L ccMA solution (0.1 M H₂SO₄) to assess partial regeneration. 4) The same catalyst subjected to reductive stripping via CA for 30 minutes, followed by testing in another fresh 0.5 g/L ccMA solution (0.1 M H₂SO₄) to evaluate complete regeneration of catalytic activity. Products formed during and after each reaction were identified and quantified to assess the impact of cysteine on the hydrogenation of ccMA.

Product analysis. Product identification and quantification were carried out using ¹H NMR spectroscopy on a Bruker Avance III 600 MHz NMR spectrometer. During the CA experiments, 600 pL aliquots were collected at regular intervals, air-dried overnight, and subsequently redissolved in 600 μL of an internal standard solution consisting of 1 g/L dimethylmalonic acid in D₂O.

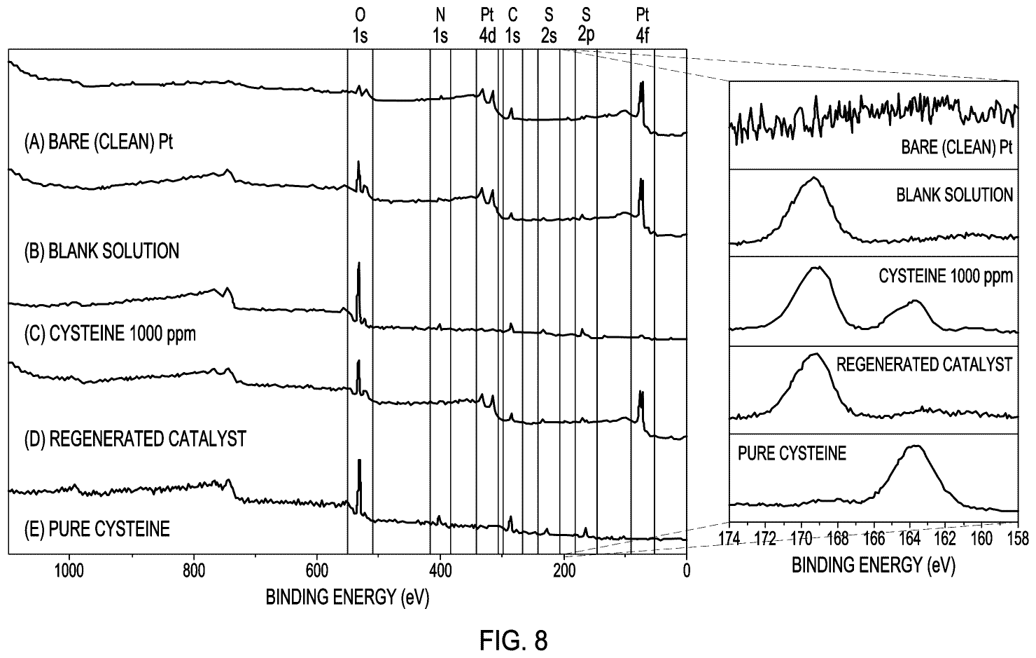

FIGS. 7-9 illustrate the results of the experiment. FIG. 7 illustrates a cyclic voltammogram of cysteine-induced poisoning and electrochemical regeneration of platinum catalyst in the HER. FIG. 8 illustrates XPS spectra illustrating platinum surface changes due to cysteine poisoning and subsequent electrochemical regeneration. FIG. 9 illustrate concentration versus time for conversion of ccMA to AA on Pt-dep-Pt foil at −1.5 V over a duration of 4 h in the batch reactor setup.

### Example 5. Electrochemical Regeneration of Platinum: Overcoming Biogenic Impurity Poisoning for the Electrocatalytic Hydrogenation of cis,cis-Muconic Acid to Biobased Adipic Acid

Technological advances in synthetic biology have revolutionized chemical manufacturing by enabling the transition from fossil-derived feedstocks to renewable biomass sources. Nevertheless, despite significant progress in metabolic engineering, achieving high-yield production of every distinct target molecule remains challenging. Consequently, there is substantial value in leveraging biomanufacturing to produce platform chemicals that can subsequently be converted into commodity chemicals through catalytic transformations. Concurrently, the field of electrocatalysis has emerged as a promising avenue for utilizing renewable electricity to drive chemical reactions, offering a sustainable alternative to traditional thermochemical processes.

The integration of these standalone technologies, biomanufacturing and electrocatalysis, offers a powerful approach to decarbonize and electrify the chemical industry. In this context, hybrid microbial electrosynthesis (HMES) represents a promising strategy, wherein biocatalytic conversion of biomass produces platform intermediates that are further upgraded to value-added products via electrocatalysis, using the fermentation broth itself as the reaction medium. By directly coupling fermentation and electrocatalytic transformations, HMES circumvents energy-intensive and costly downstream purification steps, thereby improving both process efficiency and economic feasibility.

This study focuses on cis,cis-muconic acid (ccMA), a biologically derived platform molecule that can be synthesized by engineered microorganisms, including Escherichia coli, Saccharomyces cerevisiae, and Pseudomonas putida. Notably, PTT Global Chemical has reported ccMA titers as high as 81.5 g/L using Escherichia coli (MYR1674). Electrochemically, ccMA can be hydrogenated to form monounsaturated intermediates, namely trans-2-hexenedioic acid (t2HDA) and trans-3-hexenedioic acid (t3HDA), and ultimately adipic acid (AA), a key precursor for nylon production.

Electrochemical pathways for hydrogenating ccMA have previously been identified, supported by density functional theory (DFT) calculations. These calculations suggest that the initial hydrogenation to monounsaturated acids likely proceeds via proton-coupled electron transfer (PCET) in the liquid phase, indicative of an outer-sphere process that does not require direct adsorption of ccMA onto the electrode surface. The electrochemical hydrogenation of ccMA to t3HDA using high-hydrogen-overpotential metals, such as Pb, directly in fermentation broth has been demonstrated. However, the subsequent hydrogenation of monounsaturated acids to AA follows a surface-mediated pathway, necessitating active catalyst-substrate interactions. Precious metal catalysts such as Pt, Pd, and Pd/C are commonly employed for this electrocatalytic hydrogenation (ECH) of ccMA to AA.

This framework presents a compelling opportunity to transition from electrochemical to electrocatalytic conversion of ccMA directly within the fermentation medium. However, this approach holds several challenges. Biomolecules inherently present in fermentation media, collectively referred to as biogenic impurities, are well-documented to strongly poison precious metal catalysts under thermocatalytic conditions. The extent and reversibility of this poisoning depend on several factors, including the polarity of the molecule, its binding affinity, the presence of specific functional groups (e.g., sulfur or nitrogen), bond strength, and the applied electrochemical potential. It has been demonstrated that the metal surface poisoning arises from interactions with various fermentation-derived components, including amino acids, proteins, vitamins, organic acids, and salts. Notably, sulfur- and nitrogen-containing amino acids and vitamins have been identified as major contributors to catalyst deactivation. Furthermore, literature reports indicate that precious metal catalysts such as Pd and Ru can undergo permanent deactivation in the presence of sulfur-containing amino acids, particularly cysteine and methionine, under thermocatalytic conditions.

Despite existing studies on catalyst poisoning under thermocatalytic conditions, the effect of biogenic impurities on electrocatalytic transformations remains largely unexplored. This study systematically investigates the reversible and irreversible poisoning of precious metal catalysts in electrocatalytic reactions. Focusing on platinum (Pt), the extent of catalyst poisoning in the presence of biogenic impurities is evaluated and catalyst regeneration strategies are explored. Given that sulfur-containing amino acids are among the most potent catalyst poisons, cysteine is employed as a representative model compound to assess its effect on the electrocatalytic performance of Pt.

A three-electrode electrochemical cell was employed to evaluate the effect of cysteine on the catalytic activity of platinum (Pt) for the hydrogen evolution reaction (HER), a well-established model reaction, using cyclic voltammetry (CV). These experiments were carried out in a 0.1 M H₂SO₄ electrolyte solution, where the catalytic activity was assessed based on the extent of hydrogen adsorption, quantified through the charge associated with the hydrogen underpotential deposition (H_{UPD}) region. Initially, CVs recorded in pure 0.1 M H₂SO₄ solution established a benchmark for the maximum achievable HER activity of the clean Pt surface. Upon the introduction of 1000 ppm cysteine, an immediate 80% decline in the catalytic activity was observed, directly attributed to the strong adsorption of cysteine onto the Pt surface, which blocks active hydrogen adsorption sites. FIG. 10A illustrates cyclic voltammograms showing the effect of cysteine poisoning and subsequent electrochemical regeneration of platinum (Pt) catalytic activity for the hydrogen evolution reaction (HER) in 0.1 M H₂SO₄. The introduction of 1000 ppm cysteine leads to an 80% decrease in HER activity, while electrochemical cycling in a fresh 0.1 M H₂SO₄ solution restores a substantial portion of the lost activity. FIG. 10B illustrates quantified H_{UPD} charge densities (μC/cm²) corresponding to pristine Pt, poisoned Pt, and regenerated Pt, plotted for 100 CV cycles. This pronounced deactivation aligns with prior observations of cysteine-induced catalyst poisoning, as evidenced in the conversion of lactic acid (LA) to propylene glycol (PG), where 1000 ppm cysteine led to complete deactivation of the Ru/C catalyst.

To assess the feasibility of electrochemical regeneration, the poisoned Pt catalyst was subjected to cyclic voltammetry in fresh 0.1 M H₂SO₄. Remarkably, CV cycling alone led to a substantial 76% recovery of the lost catalytic activity, ultimately restoring 86% of the activity relative to the pristine catalyst (FIGS. 10A-10B). Throughout this study, this initial recovery step is referred to as the “first regeneration”. Achieving 86% recovery of the initially lost catalytic activity is a remarkable outcome, especially when contrasted with prior thermocatalytic studies. Zhang et al. reported that Ru/C exposed to 50 ppm cysteine exhibited only partial regeneration, with up to 54% recovery of its original activity. However, at a higher cysteine concentration of 1000 ppm, irreversible catalyst deactivation was observed, attributed to the strong adsorption of sulfur-containing biomolecules such as methionine and cysteine onto the catalyst surface.

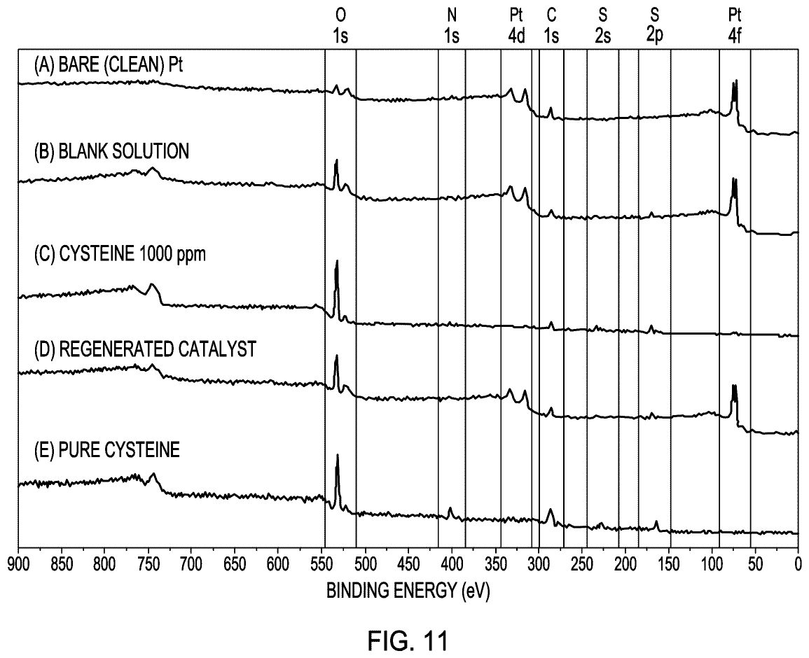

These findings were further corroborated by X-ray photoelectron spectroscopy (XPS) (FIG. 11), which was used to monitor changes in surface composition across five defined stages: (a) a thoroughly polished bare Pt electrode, (b) Pt subjected to CV cycling in blank 0.1 M H₂SO₄, (c) Pt poisoned by cycling in 0.1 M H₂SO₄ containing 1000 ppm cysteine, (d) Pt regenerated in fresh 0.1 M H₂SO₄ after poisoning, and (e) a reference spectrum of pure cysteine powder. This experimental sequence enabled direct comparison of elemental and chemical state changes on the Pt surface before and after exposure to cysteine, and following electrochemical regeneration.

Survey spectra confirmed the absence of significant contamination from any other metals, showing only trace levels of C, N, and O due to atmospheric exposure during handling. The Pt 4f peaks at 70.9 eV and 74.2 eV, attributed to metallic Pt⁰ and PtO₂, respectively, were consistently present in stages (a), (b), and (d). While the Pt peak intensities remained stable before and after regeneration, a substantial suppression was observed in the poisoned sample, indicating possible surface coverage by adsorbed cysteine-derived species. Upon regeneration, the XPS data showed a recovery in Pt peak intensities, suggesting effective desorption of the surface-bound species.

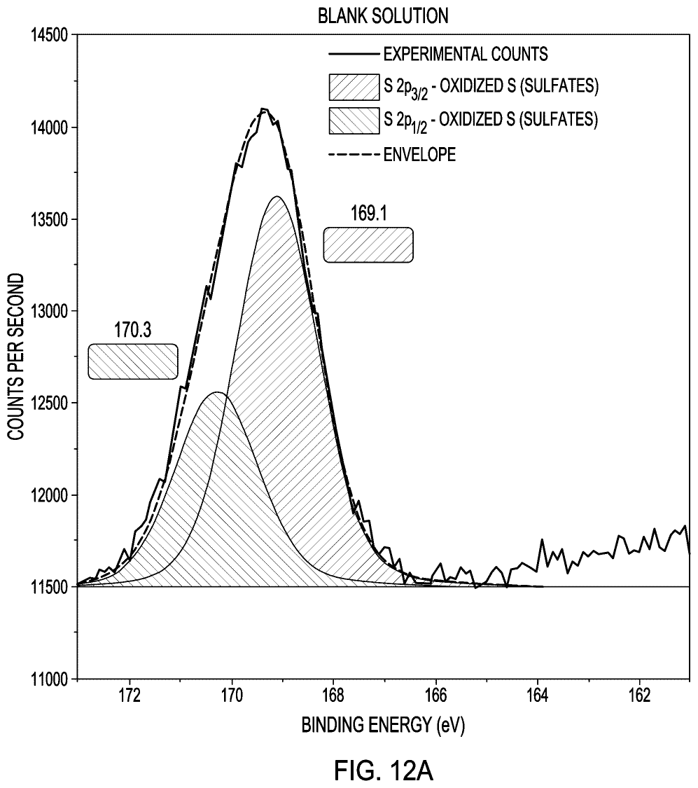

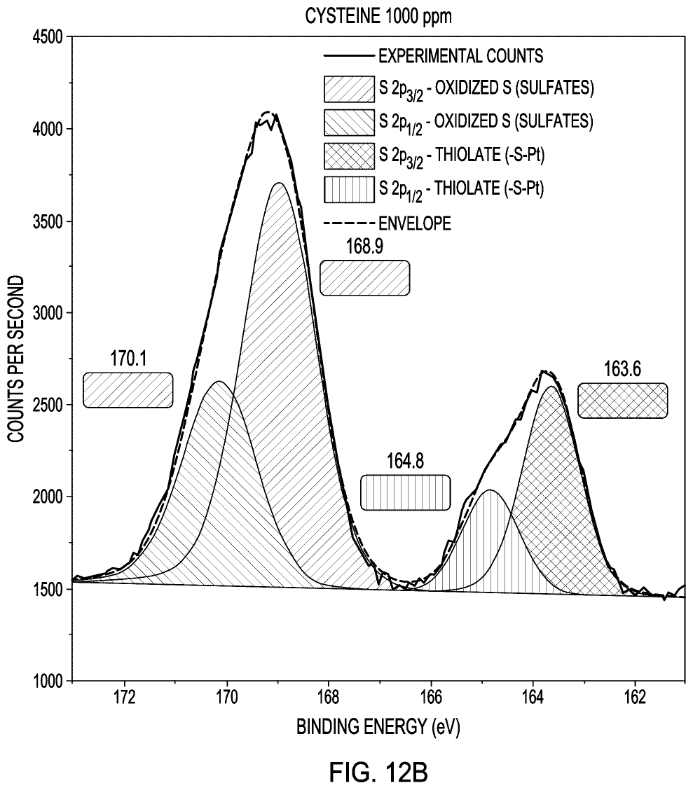

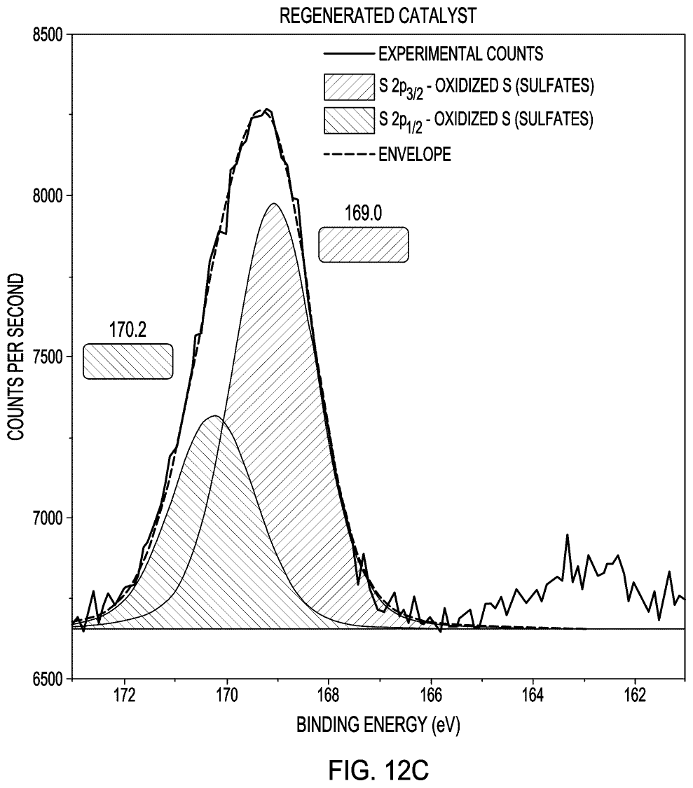

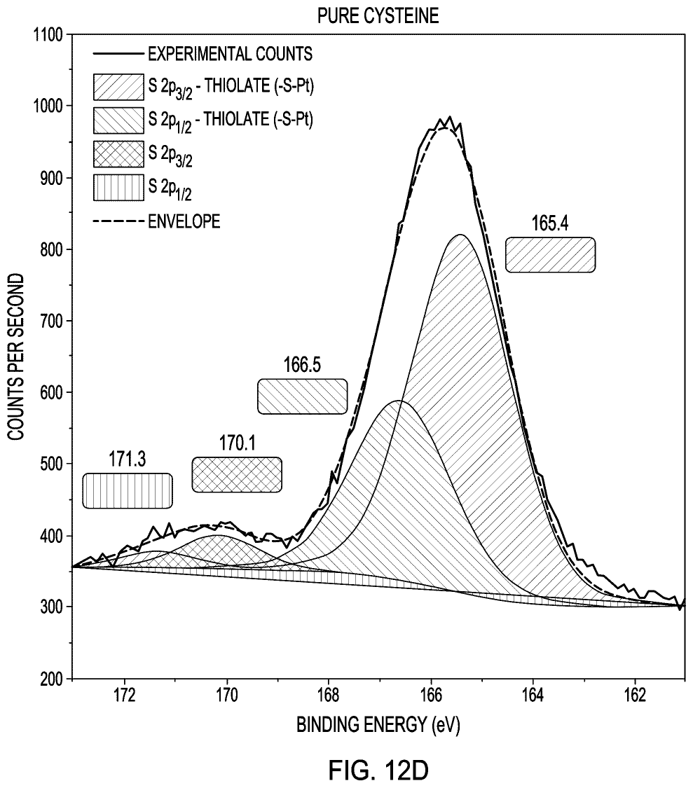

S 2p XPS spectra further elucidated the sulfur speciation at each stage (FIGS. 12A-12D). In the blank sample (FIG. 12A), two S 2p XPS peaks were observed at 169.1 eV and 170.3 eV, characteristic of sulfate species derived from the H₂SO₄ electrolyte. Upon poisoning with 1000 ppm cysteine (FIG. 12B), four distinct peaks appeared at 163.6, 164.8, 168.9, and 170.1 eV. Peaks in the 163.6-164.8 eV range correspond to thiolate and metal-sulfur species such as Pt—S and PtS₂, while peaks near 169-170 eV indicate oxidized sulfur forms, such as sulfate and sulfonate species. These assignments confirm the adsorption of cysteine on the Pt surface.

The S 2p XPS spectrum of pure cysteine powder (FIG. 12D) revealed peaks at 165.4, 166.5, 170.1, and 171.3 eV, consistent with disulfide and oxidized thiol species, as previously reported. Importantly, the poisoned Pt surface displayed peaks at 163.6 and 164.8 eV that fall within the same energetic range as reported for thiolates and metal-bound sulfurs.

After regeneration (FIG. 12C), the S 2p XPS signals returned to 169.0 and 170.2 eV, similar to those observed in the blank, suggesting the removal of surface-bound cysteine and retention of only residual sulfate from the supporting electrolyte. The disappearance of thiol-specific peaks confirms the effective desorption of cysteine from the Pt surface via electrochemical cycling.

These XPS results reinforce the electrochemical findings, demonstrating that although cysteine strongly adsorbs to Pt and causes significant deactivation, it can be reversibly removed through electrochemical regeneration, restoring the catalytic surface. These observations align with previous reports on thiol desorption from Pt surfaces and underscore the role of potential cycling in restoring catalyst performance after exposure to biogenic impurities.

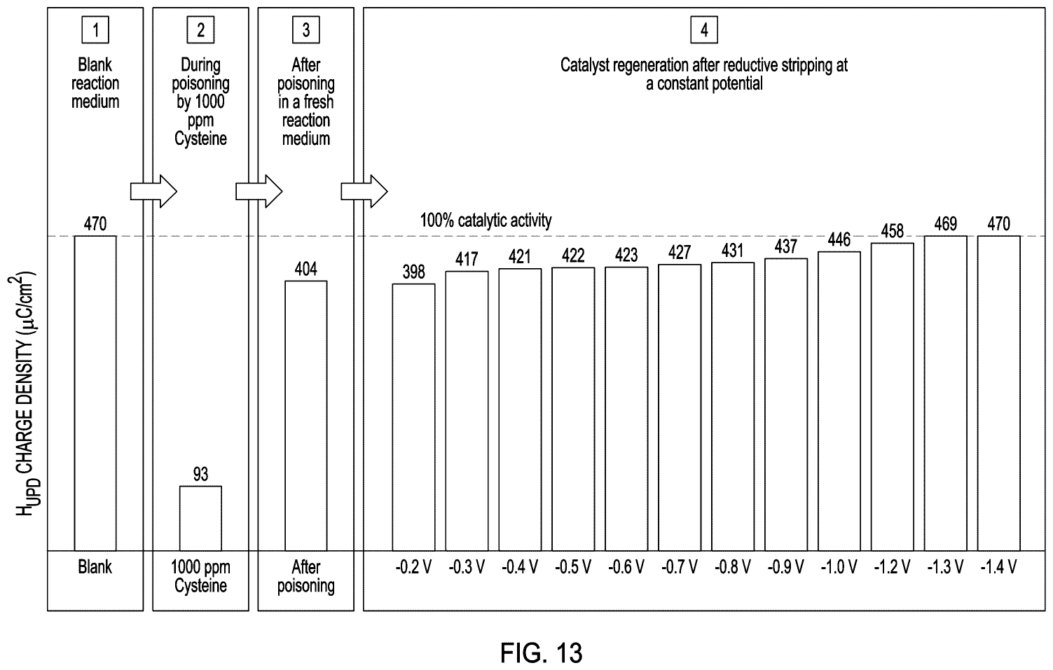

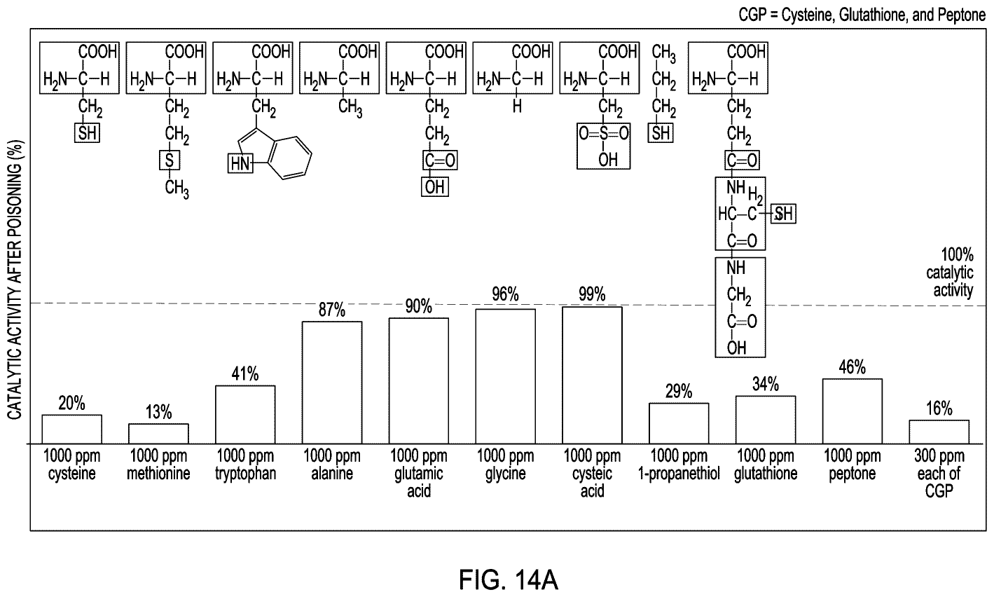

Further electrochemical regeneration of the poisoned platinum catalyst was systematically examined via reductive stripping, performed using chronoamperometry (CA) at incrementally negative potentials interspersed with CVs, to evaluate maximum achievable catalytic activity (FIG. 13). This approach aimed to determine the maximum achievable restoration of activity after cysteine poisoning. Remarkably, complete recovery of HER activity to the benchmark level established in blank H₂SO₄ was achieved following reductive stripping at −1.2 V. In contrast, under thermocatalytic conditions, sulfur-containing species such as cysteine are known to cause irreversible catalyst deactivation, with no observable activity restoration even after extensive treatment. FIG. 13 illustrates hydrogen production as quantified from the H_{UPD} region of Pt CVs for four stages: (1) in blank 0.1 M H₂SO₄, representing the pristine benchmark; (2) after poisoning with 1000 ppm cysteine, showing significant activity loss; (3) after electrochemical regeneration via CV cycling in fresh electrolyte; and (4) after reductive stripping performed by CA in 0.1 V steps from −0.2 V to −1.2 V, illustrating full restoration of catalytic activity.

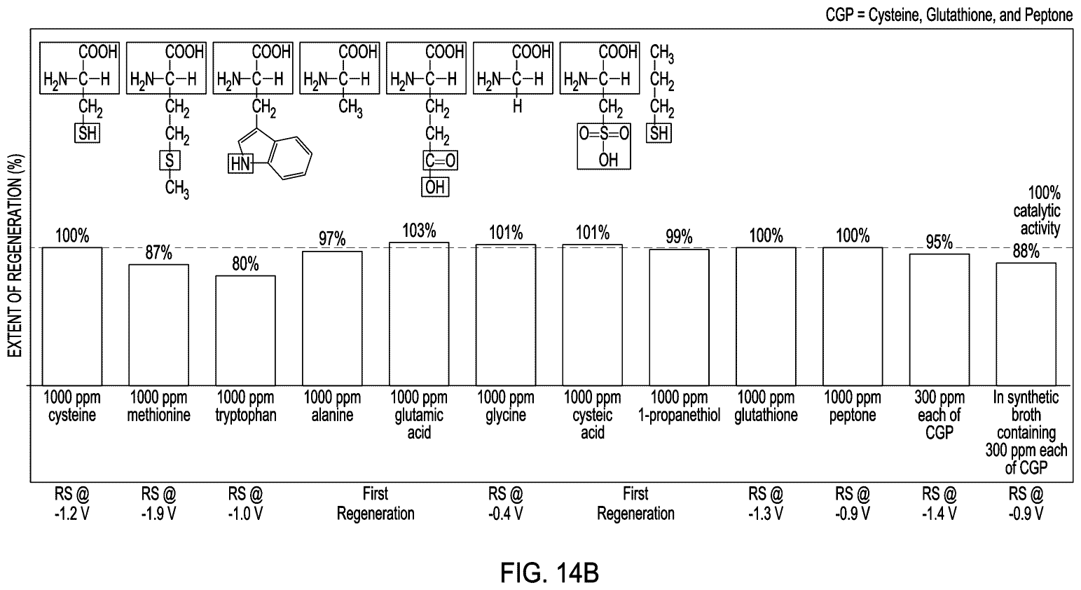

To extend the applicability of this study toward processing diverse fermentation broths, a range of biomolecules was tested to assess their impact on catalyst poisoning and regeneration (FIGS. 14A-14B). These included sulfur- and nitrogen-containing amino acids (methionine, tryptophan, alanine, glutamic acid, and glycine), peptides (glutathione), an amino acid derivative (cysteic acid), and a complex protein mixture (peptone). This selection was designed to represent various functional groups and structural complexities commonly found in fermentation media. Additionally, 1-propanethiol, a small-molecule thiol not classified as a biomolecule, was used as a positive control to benchmark the response of the Pt surface to a non-biogenic sulfur-containing compound. FIGS. 14A-14B show results highlighting the diversity in poisoning strength and regeneration efficiency across different molecular classes, with particular suppression observed for sulfur-containing species. FIG. 14A illustrates remaining catalytic activity (quantified via H_{UPD} charge) after poisoning of Pt with different biogenic impurities. FIG. 14B illustrates extent of catalytic activity recovery following electrochemical regeneration through reductive stripping (RS=reductive stripping).

Notably, the sulfur-containing amino acid, methionine, showed substantial catalyst poisoning, reducing catalytic activity to just 13% of the initial value in the presence of 1000 ppm methionine. However, electrochemical regeneration via reductive stripping up to −1.9 V resulted in 87% recovery of the original activity. In contrast, under thermocatalytic conditions, complete deactivation is typically observed for sulfur-containing compounds, especially methionine and cysteine. Similarly, 1-propanethiol caused a 71% reduction in the catalytic activity. Yet, in this case, complete activity recovery was achieved during the first regeneration step itself, indicating that surface-bound thiols can also be effectively desorbed by potential cycling within the H_{UPD} region, without the need to apply strongly negative stripping potentials. In contrast, for cysteic acid, where sulfur is present in an oxidized form, no catalyst poisoning was observed even at a concentration of 1000 ppm. Subsequent cycling in fresh 0.1 M H₂SO₄ solution for regeneration retained the maximum catalytic activity, comparable to that observed in both the initial blank and the cysteic acid-containing solution.

Moving to non-sulfur-containing amino acids with simpler side chains, alanine, glutamic acid, and glycine, did not significantly suppress the H_{UPD} region. As a result, the catalytic activity was fully recovered in the first regeneration step for each case. However, the aromatic amino acid tryptophan, despite lacking sulfur, caused a notable 59% reduction in catalytic activity. This deactivation is likely attributed to the molecule's large size and its adsorption orientation, particularly the interaction of the indole ring with the Pt surface via carbon bonding. Among all tested biomolecules, tryptophan exhibited the most incomplete regeneration, with final activity plateauing at 80% of the pristine value.

To increase the molecular complexity and simulate peptide-rich environments to move closer to fermentation broth-like conditions, glutathione, a tripeptide composed of cysteine, glutamic acid, and glycine, was tested. Given that glutamic acid and glycine showed no adverse effects individually, the 66% loss in catalytic activity observed for glutathione is attributed to the cysteine-derived thiol group. Reductive stripping at −1.3 V successfully restored the catalytic activity, mirroring the regeneration trend observed for cysteine. Extending this to an even more complex matrix, proteose peptone, a heterogeneous mixture of peptides and proteins, was evaluated. Peptone caused a 54% reduction in activity, but full regeneration was achieved at a relatively mild potential of −0.9 V, following a similar trend as glutathione.

To assess cumulative effects, a representative mixture of three key impurity classes—cysteine, glutathione, and peptone—was prepared and tested at 300 ppm each (abbreviated henceforth as CGP). CGP resulted in severe poisoning, with an 84% drop in catalytic activity, exceeding the effect of any single component (cysteine: 80%, glutathione: 66%, peptone: 54%). Nevertheless, 95% of the original activity was recovered through reductive stripping at −1.4 V.

Finally, to fully simulate fermentation broth conditions, a synthetic fermentation medium containing macro- and micronutrients was prepared, based on the composition outlined in the PTT Global Chemical patent for ccMA production. When CGP was added at 300 ppm each to this synthetic medium, the Pt surface still showed significant poisoning. However, electrochemical regeneration at −0.9 V restored catalytic activity to 88%, confirming the feasibility of using electrochemical stripping for catalyst regeneration in realistic, impurity-rich environments.

Further, the effectiveness of the regenerated catalyst in driving electrochemical transformations was validated. Given that the ECH of ccMA to AA proceeds via a surface-mediated mechanism, this reaction was employed as a model system to assess both the extent of catalyst poisoning and the efficacy of electrochemical regeneration. Since (111) facets of platinum exhibit lower activation energies and enhanced activity for surface-mediated processes, Pt(111)-rich surfaces were generated by electrodepositing Pt onto Pt foil.

Starting with a pristine catalyst, complete conversion of ccMA to AA was achieved via CA at −0.7 V for 6 hours (FIG. 15). To assess the impact of poisoning, 1000 ppm cysteine was introduced at time=0 min in a subsequent run, leading to complete deactivation of the catalyst and no ccMA conversion. Notably, when the same poisoned electrode was subjected to a second electrolysis at −0.7 V, a partial recovery of activity was observed, with 77% conversion of ccMA. This indicates that operation at −0.7 V alone can lead to partial electrochemical desorption of surface-bound sulfur species. FIG. 15 illustrates ECH of 0.5 g/L ccMA in 0.1 M H₂SO₄, showing catalytic performance of Pt at −0.7 V for 6 hours at four key stages: (1) pristine catalyst exhibiting complete conversion of ccMA to AA, (2) poisoned catalyst after exposure to 1000 ppm cysteine showing no conversion of ccMA, (3) first regeneration showing partial activity recovery during electrolysis at −0.7 V, and (4) second regeneration showing full recovery of catalytic activity after reductive stripping at −1.1 V.

To achieve full regeneration, reductive stripping was performed at −1.1 V for 30 minutes using CA. This potential was identified in prior experiments as the minimum value required to recover >97% of the H_{UPD} charge following cysteine poisoning. After reductive stripping at −1.1 V, the catalyst's activity was completely restored, as confirmed by 100% conversion of ccMA to AA within 6 hours, matching the performance of the pristine Pt surface.

This study demonstrates that sulfur-containing biogenic impurities, particularly cysteine, strongly poison platinum electrocatalysts, significantly suppressing their activity for both the HER and ECH of ccMA to AA. However, it is shown that this deactivation is not permanent under electrochemical conditions. Electrochemical regeneration via cyclic voltammetry and reductive stripping at sufficiently negative potentials (−1.1 to −1.4 V) effectively removes surface-bound sulfur species and restores catalytic performance. The extent of poisoning and regeneration varies across a range of amino acids, peptides, and protein-rich mixtures, with sulfur-containing compounds exhibiting the strongest poisoning effects. Importantly, partial to complete recovery was achieved for all the compounds, even including complex synthetic fermentation media, validating the robustness of the regeneration strategy.

These findings reveal that under electrochemical conditions, the poisoning of Pt by sulfur-containing biomolecules can be reversed, paving the way for the direct utilization of fermentation broths in electrocatalytic transformations. This is especially noteworthy given cysteine's well-documented role as a potent and irreversible catalyst poison in thermocatalysis. The integration of fermentation and electrocatalysis marks a significant step towards advancing decarbonized and electrified approaches to sustainable chemical manufacturing.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects.

The following exemplary aspects are provided, the numbering of which is not to be construed as designating levels of importance:

Aspect 1 provides an electrocatalytic method to prepare 3-hexene-1,6-dioic acid, 2-hexene-1,6-dioic acid, adipic acid, or a combination thereof, from muconic acid, the method comprising:
passing current through a catalytic cathode in a reactor comprising an aqueous solution comprising the muconic acid, a supporting electrolyte, and an anode, so as to hydrogenate the muconic acid to yield a product comprising 3-hexene-1,6-dioic acid, 2-hexene-1,6-dioic acid, adipic acid, or a mixture thereof, wherein the aqueous solution has a pH of 5.5 to 14.

Aspect 2 provides the method of Aspect 1, wherein passing the current through the cathode yields 3-hexene-1,6-dioic acid.

Aspect 3 provides the method of any one of Aspects 1-2, wherein passing the current through the cathode yields adipic acid.

Aspect 4 provides the method of any one of Aspects 1-3, wherein the muconic acid is cis,cis-muconic acid, cis,trans-muconic acid, trans,trans-muconic acid, or a combination thereof.

Aspect 5 provides the method of any one of Aspects 1-4, wherein the muconic acid is cis,cis-muconic acid.

Aspect 6 provides the method of any one of Aspects 1-5, wherein the muconic acid is cis,trans-muconic acid.

Aspect 7 provides the method of any one of Aspects 1-6, wherein the 2-hexene-1,6-dioic acid is cis-2-hexene-1,6-dioic acid, trans-2-hexene-1,6-dioic acid, or a combination thereof.

Aspect 8 provides the method of any one of Aspects 1-7, wherein the 3-hexene-1,6-dioic acid is cis-3-hexene-1,6-dioic acid, trans-3-hexene-1,6-dioic acid, or a combination thereof.

Aspect 9 provides the method of any one of Aspects 1-8, wherein the 3-hexene-1,6-dioic acid is trans-3-hexene-dioic acid.

Aspect 10 provides the method of any one of Aspects 1-9, wherein the cathode comprises at least one of Cu, Fe, Ni, Pd, Pt, Pd/C, Pb, Sn, Ti, Zn, or a combination thereof.

Aspect 11 provides the method of any one of Aspects 1-10, wherein the cathode comprises one or more platinum group metals.

Aspect 12 provides the method of any one of Aspects 1-11, wherein the cathode consists of one or more platinum group metals.

Aspect 13 provides the method of any one of Aspects 1-12, wherein the cathode comprises Ni, Pd, Pt, or a combination thereof.

Aspect 14 provides the method of any one of Aspects 1-13, wherein the cathode comprises a material that comprises one or more surface (111) facets.

Aspect 15 provides the method of Aspect 14, wherein the material that comprises one or more surface (111) facets is Pd, Pt, or a combination thereof.

Aspect 16 provides the method of any one of Aspects 14-15, wherein the material that comprises one or more surface (111) facets is on carbon.

Aspect 17 provides the method of any one of Aspects 14-16, wherein the material that comprises one or more surface (111) facets comprises Cu, Fe, Ni, Pd, Pt, Pd/C, Pb, Sn, Ti, Zn, C, Cd, V, Cr, Mn, Co, Al, Nb, Mo, Ru, In, Sm, Sb, Hf, Ta, Re, Ir, Au, Bi, W, Cu, Ag, Ga, silicon carbide, an oxide (e.g., silica, alumina), Sn, Pd—Ga alloy, Pd—Au alloy, a Pd hydride, an alloy of any two or more of the same, leaded brass, any of these materials under compressive strain, or a combination thereof.

Aspect 18 provides the method of any one of Aspects 14-17, wherein the hydrogenation yields adipic acid.

Aspect 19 provides the method of any one of Aspects 14-18, wherein the hydrogenation yields adipic acid with a selectivity of about 80% to about 100%.

Aspect 20 provides the method of any one of Aspects 1-19, wherein the cathode comprises Cu, Fe, Ni, Pd, Pt, Pd/C, Pb, Sn, Ti, Zn, C, Cd, V, Cr, Mn, Co, Al, Nb, Mo, Ru, In, Sm, Sb, Hf, Ta, Re, Ir, Au, Bi, W, Cu, Ag, Ga, Pd—Ga alloy, Pd—Au alloy, an alloy of any two or more of the same, leaded brass, or a combination thereof.

Aspect 21 provides the method of Aspect 20, wherein the method yields trans-3-hexene-1,6-dioic acid.

Aspect 22 provides the method of any one of Aspects 20-21, wherein the method yields trans-3-hexene-1,6-dioic acid with a selectivity of about 80% to about 100%, and with a conversion of about 40% to about 100%.

Aspect 23 provides the method of any one of Aspects 1-22, wherein the cathode comprises Pb, wherein the method yields trans-3-hexene-1,6-dioic acid with a selectivity of about 80% to about 100% and with a conversion of about 80% to about 100%.

Aspect 24 provides the method of any one of Aspects 1-23, wherein the cathode consists of lead.

Aspect 25 provides the method of any one of Aspects 1-24, wherein the cathode comprises platinum.

Aspect 26 provides the method of any one of Aspects 1-25, wherein the cathode consists of platinum.

Aspect 27 provides the method of any one of Aspects 1-26, wherein the cathode comprises one or more transition metals.

Aspect 28 provides the method of any one of Aspects 1-27, wherein the cathode consists of one or more transition metals.

Aspect 29 provides the method of any one of Aspects 1-28, wherein the aqueous solution comprises an organic acid, a mineral acid, a salt thereof, added H₂, or a combination thereof.

Aspect 30 provides the method of any one of Aspects 1-29, wherein the aqueous solution comprises formic acid, sulfuric acid, a salt thereof, added H₂, or a combination thereof.

Aspect 31 provides the method of any one of Aspects 1-28, wherein other than the muconic acid and hydrogenation products thereof, the aqueous solution is substantially free of added acid.

Aspect 32 provides the method of Aspect 31, wherein the added acid is 0 wt % to 0.01 wt % of the aqueous solution.

Aspect 33 provides the method of any one of Aspects 1-28 and 31-32, wherein other than the muconic acid and hydrogenation products thereof, the aqueous solution is substantially free of added organic acids and added mineral acids.

Aspect 34 provides the method of any one of Aspects 1-28 and 31-33, wherein other than hydrogen generated on the anode or the cathode, the aqueous solution is free of added H₂.

Aspect 35 provides the method of any one of Aspects 1-34, wherein the aqueous solution has a pH of 5.5-8.

Aspect 36 provides the method of any one of Aspects 1-35, wherein the aqueous solution has a pH of 6.5-7.5.

Aspect 37 provides the method of any one of Aspects 1-36, wherein the aqueous solution has a pH of about 7.

Aspect 38 provides the method of any one of Aspects 1-37, wherein the aqueous solution has a concentration of the muconic acid of 0.01 g/L to 150 g/L.

Aspect 39 provides the method of any one of Aspects 1-38, wherein the aqueous solution has a concentration of at least 10 g/L.

Aspect 40 provides the method of any one of Aspects 1-39, wherein the aqueous solution has a concentration of at least 50 g/L.

Aspect 41 provides the method of any one of Aspects 1-40, wherein the current is generated by applying a voltage of about +0.1 to about −5.0 volts with respect to an Ag/AgCl reference electrode or with respect to a reversible hydrogen electrode.

Aspect 42 provides the method of any one of Aspects 1-41, wherein the method is carried out at ambient temperature and pressure.

Aspect 43 provides the method of any one of Aspects 1-42, wherein the method converts the muconic acid to the trans-3-hexene-1,6-dioic acid at a selectivity of about 80% to about 100%.

Aspect 44 provides the method of any one of Aspects 1-43, wherein the method converts the muconic acid to the trans-3-hexene-1,6-dioic acid at a selectivity of about 95% to about 100%.

Aspect 45 provides the method of any one of Aspects 1-44, wherein the method hydrogenates about 0.01% to about 100% of the muconic acid.

Aspect 46 provides the method of any one of Aspects 1-45, wherein the method hydrogenates about 80% to about 100% of the muconic acid.

Aspect 47 provides the method of any one of Aspects 1-46, wherein the hydrogenation of the muconic acid occurs with a faradaic efficiency of about 2% to about 100%.

Aspect 48 provides the method of any one of Aspects 1-47, wherein the hydrogenation of the muconic acid occurs with a faradaic efficiency of about 30% to about 100%.

Aspect 49 provides the method of any one of Aspects 1-48, wherein during the hydrogenation the cathode has a catalytic turnover frequency of about 0.01 s⁻¹ to about 120 s⁻¹.

Aspect 50 provides the method of any one of Aspects 1-49, wherein during the hydrogenation the cathode has a catalytic turnover frequency of about 0.10 s⁻¹ to about 35 s⁻¹.

Aspect 51 provides the method of any one of Aspects 1-50, wherein the aqueous solution comprises a fermentation broth comprising the muconic acid.

Aspect 52 provides the method of Aspect 51, wherein the fermentation broth comprises glucose and supports the conversion of glucose into muconic acid by yeast and/or bacteria.

Aspect 53 provides the method of any one of Aspects 51-52, wherein the fermentation broth comprises yeast nitrogen base.

Aspect 54 provides the method of Aspect 53, wherein the yeast nitrogen base is substantially free of amino acids, ammonium sulfate, or a combination thereof.

Aspect 55 provides the method of any one of Aspects 51-54, wherein the fermentation broth comprises ammonium sulfate.

Aspect 56 provides the method of any one of Aspects 51-55, wherein the fermentation broth comprises complete supplement mixture (CSM) uracil-dropout amino acid mix.

Aspect 57 provides the method of any one of Aspects 51-56, wherein the method comprises at least partially simultaneously fermenting the broth to form muconic acid and hydrogenating muconic acid in the broth.

Aspect 58 provides the method of any one of Aspects 51-57, wherein the fermentation broth comprises one or more catalyst poisons, wherein the method further comprises removing at least some of the one or more catalyst poisons from the catalytic cathode to form a rejuvenated catalytic cathode.

Aspect 59 provides the method of Aspect 58, wherein the one or more catalyst poisons comprise one or more amino acids.

Aspect 60 provides the method of any one of Aspects 58-59, wherein the one or more catalyst poisons comprise methionine, cysteine, tryptophan, glutamic acid, alanine, proteose peptone, or a combination thereof.

Aspect 61 provides the method of any one of Aspects 58-60, wherein the catalytic cathode comprises a material comprising a (100) facet, (110) facet, (111) facet, or a combination thereof, at its surface.

Aspect 62 provides the method of Aspect 61, wherein the catalytic cathode comprises Pd comprising a surface (100) facet, (110) facet, (111) facet, or a combination thereof and/or Pt comprising a surface (100) facet, (110) facet, (111) facet, or a combination thereof.

Aspect 63 provides the method of any one of Aspects 58-62, wherein the method further comprises reusing the rejuvenated catalytic cathode in the method as the catalytic cathode.

Aspect 64 provides the method of Aspect 58-63, wherein the one or more catalyst poisons comprise a sulfur-containing amino acid, a nitrogen-containing amino acid, a peptide, a protein, a vitamin, an organic acid, a salt, or a combination thereof.

Aspect 65 provides the method of Aspect 64, wherein the sulfur-containing amino acid comprises cysteine, methionine, or a combination thereof.

Aspect 66 provides the method of any one of Aspects 64-65, wherein the nitrogen-containing amino acid comprises tryptophan, and wherein the one or more catalyst poisons can optionally comprise alanine, glutamic acid, glycine, or a combination thereof.

Aspect 67 provides the method of any one of Aspects 64-66, wherein the peptide comprises glutathione, proteose peptone, or a combination thereof.

Aspect 68 provides the method of any one of Aspects 58-67, wherein the removing of the one or more catalyst poisons comprises applying a reductive stripping potential to the catalytic cathode.

Aspect 69 provides the method of Aspect 68, wherein the reductive stripping potential is about −0.9 V to about −1.9 V versus Ag/AgCl.

Aspect 70 provides the method of Aspect 68, wherein the reductive stripping potential is about −1.1 V to about −1.4 V versus Ag/AgCl.

Aspect 71 provides the method of any one of Aspects 58-70, wherein the removing of the one or more catalyst poisons comprises cyclic voltammetry in a fresh electrolyte solution substantially free of the one or more catalyst poisons.

Aspect 72 provides the method of Aspect 71, wherein the fresh electrolyte solution comprises 0.1 M H₂SO₄.

Aspect 73 provides the method of any one of Aspects 58-72, wherein the removing comprises chronoamperometry at a constant reductive potential for about 10 minutes to about 60 minutes.

Aspect 74 provides the method of Aspect 73, wherein the constant reductive potential is applied for about 30 minutes.

Aspect 75 provides the method of any one of Aspects 58-74, wherein the catalytic cathode comprises platinum electrodeposited on a platinum substrate to form Pt(111)-rich surfaces.

Aspect 76 provides the method of any one of Aspects 58-74, wherein the catalytic cathode comprises a material comprising a (100) facet, (110) facet, (111) facet, or a combination thereof, at its surface, selected from the group consisting of Pd, Pt, Pd/C, Pt/C, or a combination thereof.

Aspect 77 provides the method of any one of Aspects 58-76, wherein the one or more catalyst poisons reduce catalytic activity of the catalytic cathode by about 50% to about 95% compared to a pristine cathode.

Aspect 78 provides the method of Aspect 77, wherein the one or more catalyst poisons reduce catalytic activity by about 80% to about 90%.

Aspect 79 provides the method of any one of Aspects 58-78, wherein the rejuvenated catalytic cathode has a catalytic activity that is about 80% to about 100% of an original catalytic activity prior to poisoning.

Aspect 80 provides the method of Aspect 79, wherein the rejuvenated catalytic cathode has a catalytic activity that is about 95% to about 100% of the original catalytic activity.

Aspect 81 provides the method of any one of Aspects 58-80, wherein the catalytic activity is assessed by hydrogen underpotential deposition (H_{UPD}) charge density measurements.

Aspect 82 provides the method of any one of Aspects 58-81, wherein the method comprises analyzing the surface of the catalytic cathode to confirm removal of surface-bound species by a technique selected from the group consisting of X-ray photoelectron spectroscopy (XPS), cyclic voltammetry, or a combination thereof.

Aspect 83 provides the method of any one of Aspects 58-82, wherein the fermentation broth comprises a synthetic fermentation medium containing macro-nutrients and micro-nutrients.

Aspect 84 provides the method of any one of Aspects 58-83, wherein the method achieves complete or substantially complete conversion of the muconic acid after one or more cycles of poisoning and electrochemical regeneration.

Aspect 85 provides the method of any one of Aspects 58-84, wherein the electrochemical regeneration restores the catalytic activity to a level sufficient to achieve at least 80% conversion of muconic acid to adipic acid.

Aspect 86 provides the method of any one of Aspects 58-85, wherein the method comprises monitoring the catalytic activity of the catalytic cathode and initiating electrochemical regeneration when a decrease in activity is detected.

Aspect 87 provides the method of any one of Aspects 58-86, wherein the method comprises sequentially or simultaneously performing electrocatalytic hydrogenation and electrochemical regeneration of the catalytic cathode, thereby enabling continuous or semi-continuous operation.

Aspect 88 provides the method of any one of Aspects 58-87, wherein the method is performed in a fermentation broth comprising a mixture of biogenic impurities, and wherein the electrochemical regeneration restores the catalytic activity of the cathode to a level sufficient to achieve at least 80% conversion of muconic acid to adipic acid.

Aspect 89 provides the method of any one of Aspects 1-88, further comprising polymerizing the adipic acid with another compound, to form a polymer.

Aspect 90 provides the method of any one of Aspects 1-89, further comprising polymerizing the adipic acid with a compound having the structure H₂N—(C₁-C₂₀)alkylene-NH₂, HO—(C₁-C₂₀)alkylene-NH₂, HO—(C₁-C₂₀)alkylene-OH, a salt thereof, or a combination thereof, wherein the (C₁-C₂₀)alkylene group is substituted or unsubstituted, to form a polymer.

Aspect 91 provides the method of any one of Aspects 1-90, further comprising polymerizing the adipic acid with hexamethylenediamine, wherein the polymer is nylon 6,6.

Aspect 92 provides the method of any one of Aspects 1-91, further comprising:
polymerizing the 2-hexene-1,6-dioic acid, the 3-hexene-1,6-dioic acid, or a combination thereof, with another compound, to form a polymer.

Aspect 93 provides the method of any one of Aspects 1-92, further comprising:
polymerizing the 2-hexene-1,6-dioic acid, the 3-hexene-1,6-dioic acid, the adipic acid, or a combination thereof, with a compound having the structure H₂N—(C₁-C₂₀)alkylene-NH₂, HO—(C₁-C₂₀)alkylene-NH₂, HO—(C₁-C₂₀)alkylene-OH, a salt thereof, or a combination thereof, wherein the (C₁-C₂₀)alkylene group is substituted or unsubstituted, to form a polymer.

Aspect 94 provides the method of Aspect 93, wherein the polymerizing forms a polymer comprising a repeating group having the structure:

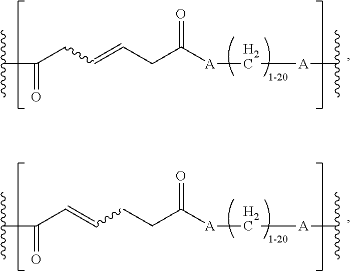

a salt thereof, or a combination thereof, wherein at each occurrence -A- is independently chosen from —NH— and —O—.

Aspect 95 provides the method of any one of Aspects 93-94, wherein the polymerizing forms a polymer comprising a repeating group having the structure:

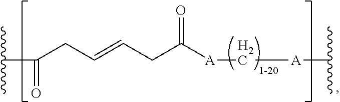

or a salt thereof, wherein at each occurrence -A- is independently chosen from —NH— and —O—.

Aspect 96 provides the method of any one of Aspects 1-95, further comprising:
polymerizing the 2-hexene-1,6-dioic acid, the 3-hexene-1,6-dioic acid, or a combination thereof, with hexamethylenediamine, wherein the polymerizing forms a polymer comprising a repeating group having the structure:

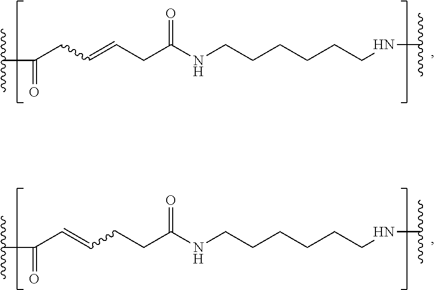

a salt thereof, or a combination thereof.

Aspect 97 provides the method of any one of Aspects 1-96, further comprising:
polymerizing the adipic acid with hexamethylenediamine, wherein the polymerizing forms a polymer comprising a repeating group having the structure:

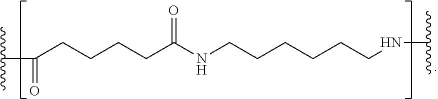

Aspect 98 provides an electrocatalytic method to prepare adipic acid from muconic acid, the method comprising:
passing current through a catalytic cathode comprising Pd on carbon, or Pt on carbon, or a combination thereof, wherein the Pd and Pt comprises a (111) facet at its surface, wherein the catalytic cathode is in a reactor comprising an aqueous solution comprising the muconic acid, a supporting electrolyte, and an anode, so as to hydrogenate the muconic acid so as to yield a product comprising adipic acid with a selectivity of about 40% to about 100%.

Aspect 99 provides an electrocatalytic method to prepare adipic acid from cis,cis-muconic acid, the method comprising:
passing current through a catalytic cathode comprising Pd on carbon, or Pt on carbon, or a combination thereof, wherein the Pd and Pt comprises a (111) facet at its surface, wherein the catalytic cathode is in a reactor comprising an aqueous solution comprising the cis,cis-muconic acid, a supporting electrolyte, and an anode, so as to hydrogenate the cis,cis-muconic acid so as to yield a product comprising adipic acid with a selectivity of about 40% to about 100%.

Aspect 100 provides an electrocatalytic method to prepare adipic acid from muconic acid, the method comprising:
passing current through a catalytic cathode comprising a material that comprises a (111) facet at its surface, wherein the catalytic cathode is in a reactor comprising an aqueous solution comprising the muconic acid, a supporting electrolyte, and an anode, so as to hydrogenate the muconic acid so as to yield a product comprising adipic acid with a selectivity of about 40% to about 100%.

Aspect 101 provides an electrocatalytic method to prepare adipic acid from cis,cis-muconic acid, the method comprising:
passing current through a catalytic cathode comprising a material that comprises a (111) facet at its surface, wherein the catalytic cathode is in a reactor comprising an aqueous solution comprising the cis,cis-muconic acid, a supporting electrolyte, and an anode, so as to hydrogenate the cis,cis-muconic acid so as to yield a product comprising adipic acid with a selectivity of about 40% to about 100%.

Aspect 102 provides a method to prepare trans-3-hexene-1,6-dioic acid from muconic acid, the method comprising:
passing current through a cathode comprising Cu, Fe, Ni, Pd, Pt, Pd/C, Pb, Sn, Ti, Zn, C, Cd, V, Cr, Mn, Co, Al, Nb, Mo, Ru, In, Sm, Sb, Hf, Ta, Re, Ir, Au, Bi, W, Cu, Ag, Ga, Pd—Ga alloy, Pd—Au alloy, an alloy of any two or more of the same, leaded brass, or a combination thereof, wherein the catalytic cathode is in a reactor comprising an aqueous solution comprising muconic acid and having a pH of 5.5 to 14, a supporting electrolyte, and an anode, so as to hydrogenate the muconic acid so as to yield a product comprising trans-3-hexene-1,6-dioic acid with a selectivity of about 50% to about 100%.

Aspect 103 provides an electrocatalytic method to prepare 3-hexene-1,6-dioic acid, 2-hexene-1,6-dioic acid, adipic acid, or a combination thereof, from muconic acid, the method comprising:
passing current through a catalytic cathode in a reactor comprising an aqueous solution comprising the muconic acid, a supporting electrolyte, and an anode, so as to hydrogenate the muconic acid to yield a product comprising 3-hexene-1,6-dioic acid, 2-hexene-1,6-dioic acid, adipic acid, or a mixture thereof, wherein the aqueous solution comprises a fermentation broth comprising the muconic acid and comprising one or more catalyst poisons;
removing at least some of the one or more catalyst poisons from the catalytic cathode, to form a rejuvenated catalytic cathode; and
reusing the rejuvenated catalytic cathode as the catalytic cathode in the method.

Aspect 104 provides an electrocatalytic method comprising:
passing current through a catalytic cathode in a reactor comprising an aqueous solution comprising an organic substrate, a supporting electrolyte, and an anode, so as to electrocatalytically convert the organic substrate, wherein the aqueous solution comprises a fermentation broth comprising the organic substrate and comprising one or more catalyst poisons that reduce catalytic activity of the catalytic cathode;
removing one or more catalyst poisons from the catalytic cathode to form a rejuvenated catalytic cathode; and
reusing the rejuvenated catalytic cathode in the method.

Aspect 105 provides the method of Aspect 104, wherein the electrocatalytically converting comprises hydrogenating an unsaturated organic compound, wherein the organic substrate comprises the unsaturated organic compound.

Aspect 106 provides the method of Aspect 105, wherein the unsaturated organic compound comprises muconic acid, and wherein the hydrogenating yields a product comprising 3-hexene-1,6-dioic acid, 2-hexene-1,6-dioic acid, adipic acid, or a mixture thereof.

Aspect 107 provides the method of any one of Aspects 104-106, wherein the removing of the one or more catalyst poisons comprises applying a reductive stripping potential to the catalytic cathode.

Aspect 108 provides the method of Aspect 107, wherein the reductive stripping potential is about −0.9 V to about −1.9 V versus Ag/AgCl.

Aspect 109 provides the method of Aspect 107, wherein the reductive stripping potential is about −1.1 V to about −1.4 V versus Ag/AgCl.

Aspect 110 provides the method of any one of Aspects 104-109, wherein the removing of the one or more catalyst poisons comprises cyclic voltammetry in a fresh electrolyte solution substantially free of the one or more catalyst poisons.

Aspect 111 provides the method of Aspect 110, wherein the fresh electrolyte solution comprises 0.1 M H₂SO₄.

Aspect 112 provides the method of any one of Aspects 104-111, wherein the one or more catalyst poisons comprise an amino acid, a peptide, a protein, a vitamin, an organic acid, a salt, or a combination thereof.

Aspect 113 provides the method of any one of Aspects 104-112, wherein the one or more catalyst poisons comprise a sulfur-containing amino acid, a nitrogen-containing amino acid, a peptide, a protein, or a combination thereof.

Aspect 114 provides the method of Aspect 113, wherein the sulfur-containing amino acid comprises cysteine, methionine, or a combination thereof.

Aspect 115 provides the method of any one of Aspects 113-114, wherein the nitrogen-containing amino acid comprises tryptophan, wherein the one or more catalyst poisons optionally further comprise alanine, glutamic acid, glycine, or a combination thereof.

Aspect 116 provides the method of any one of Aspects 113-115, wherein the peptide comprises glutathione, proteose peptone, or a combination thereof.

Aspect 117 provides the method of any one of Aspects 104-116, wherein the catalytic cathode comprises platinum electrodeposited on a platinum substrate to form Pt(111)-rich surfaces.

Aspect 118 provides the method of any one of Aspects 104-116, wherein the catalytic cathode comprises a material comprising a (100) facet, (110) facet, (111) facet, or a combination thereof, at its surface, chosen from Pd, Pt, Pd/C, Pt/C, or a combination thereof.

Aspect 119 provides the method of any one of Aspects 104-118, wherein the one or more catalyst poisons reduce catalytic activity of the catalytic cathode by about 50% to about 95% compared to a pristine cathode.

Aspect 120 provides the method of any one of Aspects 104-119, wherein the one or more catalyst poisons reduce catalytic activity of the catalytic cathode by about 80% to about 90% compared to a pristine cathode.

Aspect 121 provides the method of any one of Aspects 104-120, wherein the rejuvenated catalytic cathode has a catalytic activity that is about 80% to about 100% of an original catalytic activity prior to poisoning.

Aspect 122 provides the method of Aspect 121, wherein the rejuvenated catalytic cathode has a catalytic activity that is about 95% to about 100% of the original catalytic activity.

Aspect 123 provides the method of any one of Aspects 104-122, wherein the removing comprises chronoamperometry at a constant reductive potential for about 10 minutes to about 60 minutes.

Aspect 124 provides the method of Aspect 123, wherein the constant reductive potential is applied for about 30 minutes.

Aspect 125 provides the method of any one of Aspects 104-124, wherein the catalytic activity is assessed by hydrogen underpotential deposition (H_{UPD}) charge density measurements.

Aspect 126 provides the method of any one of Aspects 104-125, wherein the removing is performed in a fresh aqueous electrolyte solution substantially free of the one or more catalyst poisons.

Aspect 127 provides the method of any one of Aspects 104-126, wherein the fermentation broth comprises a synthetic fermentation medium containing macro-nutrients and micro-nutrients.

Aspect 128 provides the method of any one of Aspects 104-127, wherein the method achieves complete or substantially complete conversion of the organic substrate after one or more cycles of poisoning and electrochemical regeneration.

Aspect 129 provides the method of any one of Aspects 104-128, wherein the method comprises monitoring the catalytic activity of the catalytic cathode and initiating electrochemical regeneration when a decrease in activity is detected.

Aspect 130 provides the method of any one of Aspects 104-129, wherein the method comprises sequentially or simultaneously performing electrocatalytic conversion and electrochemical regeneration of the catalytic cathode, thereby enabling continuous or semi-continuous operation.

Aspect 131 provides the method of any one of Aspects 104-130, wherein the method comprises analyzing the surface of the catalytic cathode to confirm removal of surface-bound species by a technique selected from the group consisting of X-ray photoelectron spectroscopy (XPS), cyclic voltammetry, or a combination thereof.

Aspect 132 provides the method of any one of Aspects 104-131, wherein the electrochemical regeneration restores the catalytic activity to a level sufficient to achieve at least 80% conversion of the organic substrate.

Aspect 133 provides the method of any one of Aspects 106-132, wherein the electrochemical regeneration restores the catalytic activity to a level sufficient to achieve at least 80% conversion of muconic acid to adipic acid.

Aspect 134 provides an electrocatalytic hydrogenation method comprising:
passing current through a catalytic cathode in a reactor comprising an aqueous solution comprising an unsaturated organic compound, a supporting electrolyte, and an anode, so as to hydrogenate the unsaturated organic compound, wherein the aqueous solution comprises a fermentation broth comprising the unsaturated organic compound and comprising one or more catalyst poisons;
removing one or more catalyst poisons from the catalytic cathode to form a rejuvenated catalytic cathode; and
reusing the rejuvenated catalytic cathode in the method.

Aspect 135 provides an electrocatalytic hydrogenation method to prepare 3-hexene-1,6-dioic acid, 2-hexene-1,6-dioic acid, adipic acid, or a combination thereof, from muconic acid, the method comprising:
passing current through a catalytic cathode in a reactor comprising an aqueous solution comprising the muconic acid, a supporting electrolyte, and an anode, so as to hydrogenate the muconic acid to yield a product comprising 3-hexene-1,6-dioic acid, 2-hexene-1,6-dioic acid, adipic acid, or a mixture thereof, wherein the aqueous solution comprises a fermentation broth comprising the muconic acid and comprising one or more catalyst poisons;
removing one or more catalyst poisons from the catalytic cathode to form a rejuvenated catalytic cathode; and
reusing the rejuvenated catalytic cathode as the catalytic cathode in the method.

Aspect 136 provides the apparatus, method, composition, or system of any one or any combination of Aspects 1-135 optionally configured such that all elements or options recited are available to use or select from.

What is claimed is:

1. An electrocatalytic method to prepare 3-hexene-1,6-dioic acid, 2-hexene-1,6-dioic acid, adipic acid, or a combination thereof, from muconic acid, the method comprising:
passing current through a catalytic cathode in a reactor comprising an aqueous solution comprising the muconic acid, a supporting electrolyte, and an anode, so as to hydrogenate the muconic acid to yield a product comprising 3-hexene-1,6-dioic acid, 2-hexene-1,6-dioic acid, adipic acid, or a mixture thereof, wherein the aqueous solution has a pH of 5.5 to 14.

2. The method of claim 1, wherein passing the current through the cathode yields 3-hexene-1,6-dioic acid.

3. The method of claim 1, wherein passing the current through the cathode yields adipic acid.

4. The method of claim 1, wherein the cathode comprises at least one of Cu, Fe, Ni, Pd, Pt, Pd/C, Pb, Sn, Ti, Zn, C, Cd, V, Cr, Mn, Co, Al, Nb, Mo, Ru, In, Sm, Sb, Hf, Ta, Re, Ir, Au, Bi, W, Cu, Ag, Ga, Pd—Ga alloy, Pd—Au alloy, an alloy of any two or more of the same, leaded brass, or a combination thereof.

5. The method of claim 1, wherein the cathode comprises one or more platinum group metals.

6. The method of claim 1, wherein the cathode comprises Ni, Pd, Pt, or a combination thereof.

7. The method of claim 1, wherein the cathode comprises a material that comprises one or more (100) facets, (110) facets, (111) facets, or a combination thereof, at its external surface.

8. The method of claim 7, wherein the material that comprises one or more surface (100) facets, (110) facets, (111) facets, or a combination thereof, comprises Cu, Fe, Ni, Pd, Pt, Pd/C, Pb, Sn, Ti, Zn, C, Cd, V, Cr, Mn, Co, Al, Nb, Mo, Ru, In, Sm, Sb, Hf, Ta, Re, Ir, Au, Bi, W, Cu, Ag, Ga, silicon carbide, an oxide (e.g., silica, alumina), Sn, Pd—Ga alloy, Pd—Au alloy, a Pd hydride, an alloy of any two or more of the same, leaded brass, any of these materials under compressive strain, or a combination thereof.

9. The method of claim 7, wherein the hydrogenation yields adipic acid with a selectivity of about 80% to about 100%.

10. The method of claim 1, wherein other than the muconic acid and hydrogenation products thereof, the aqueous solution is substantially free of added acid.

11. The method of claim 1, wherein other than hydrogen generated on the anode or the cathode, the aqueous solution is free of added H₂.

12. The method of claim 1, wherein the aqueous solution has a pH of 5.5-8.

13. The method of claim 1, wherein the current is generated by applying a voltage of about +0.1 volts to about −5.0 volts with respect to an Ag/AgCl reference electrode or with respect to a reversible hydrogen electrode.

14. The method of claim 1, wherein the method is carried out at ambient temperature and pressure.

15. The method of claim 1, wherein the aqueous solution comprises a fermentation broth comprising yeast and/or bacteria and comprising the muconic acid.

16. The method of claim 15, wherein the fermentation broth comprises one or more catalyst poisons comprising one or more amino acids, wherein the method further comprises removing at least some of the one or more catalyst poisons from the catalytic cathode to form a rejuvenated catalytic cathode.

17. The method of claim 16, wherein the method further comprises reusing the rejuvenated catalytic cathode in the method as the catalytic cathode.

18. The method of claim 1, further comprising:
polymerizing the 2-hexene-1,6-dioic acid, the 3-hexene-1,6-dioic acid, the adipic acid, or a combination thereof, with another compound, to form a polymer.

19. An electrocatalytic method to prepare adipic acid from muconic acid, the method comprising:
passing current through a catalytic cathode comprising a material that comprises a surface (111) facet, wherein the catalytic cathode is in a reactor comprising an aqueous solution comprising the muconic acid, a supporting electrolyte, and an anode, so as to hydrogenate the muconic acid so as to yield a product comprising adipic acid with a selectivity of about 40% to about 100%.

20. An electrocatalytic method comprising:
passing current through a catalytic cathode in a reactor comprising an aqueous solution comprising an organic substrate, a supporting electrolyte, and an anode, so as to electrocatalytically convert the organic substrate, wherein the aqueous solution comprises a fermentation broth comprising the organic substrate and comprising one or more catalyst poisons that reduce catalytic activity of the catalytic cathode;
removing one or more catalyst poisons from the catalytic cathode to form a rejuvenated catalytic cathode; and
reusing the rejuvenated catalytic cathode in the method.
